(19) United States
(12) Patent Application Publication
(10) Pub. No.: US 2024/0053753 A1
(43) Pub. Date: Feb. 15, 2024

(54) Method and system for converting a start-object situation into a target-object situation (Intuitive Tacit Solution Finding)

(71) Applicant: André STUTH, Leipzig (DE)

(72) Inventor: André STUTH, Leipzig (DE)

(21) Appl. No.: 18/259,125

(22) PCT Filed: Dec. 24, 2021
(86) PCT No.: PCT/EP2021/087645

§ 371 Date: Jun. 23, 2023

(30) Foreign Application Priority Data
Dec. 24, 2020 (LU) 102362

(51) Int. Cl. G05D 1/02; G05D 1/00

(52) U.S. Cl. CPC G05D 1/0212; G05D 1/0016; G05D 1/0061; G05D 1/0246

(57) ABSTRACT

The present invention provides a method for the adaptive control of a process or a control system, in particular for the automated finding of the solution to a problem or a task, in particular with the collection and/or use of procedural event knowledge, comprising: defining a task, which consists in converting a specific start-object situation into a specific target-object situation with the aid of an event sequence, reading a database for the purpose of searching for a suitable solution in the form of an event sequence which is suitable for solving the task, the database being suitable for associating at least the following variables with one another: an identifier of a possible start-object situation, identifiers of a possible target-object situation, identifiers of the involved object kinds, an information about an event sequence, wherein the event sequence is suitable to transfer the possible start-object situation into the possible target-object situation, selecting a procedural event sequence as a solution matching the task in the database, if a solution matching the task has been read, or forming a new event sequence, if a solution matching the task has not been read, as n-concatenation from the existing event sequences, comprising the following steps: Reading the database for the purpose of searching at least a first and an n-th event sequence, in particular searching event sequences from a first to an n-th event sequence, where n denotes a natural number and the first event sequence is suitable for transforming the possible start-object situation into a first intermediate object situation and for all natural numbers, for which 1<k<n, the kth event sequence is suitable for converting a (k−1)th intermediate object situation into a kth intermediate object situation, and the nth event sequence is suitable for converting an (n−1)th intermediate object situation into the possible target-object situation, if necessary, storing a newly created event sequence as n-concatenation in the database, the new concatenated event sequence being suitable for converting the possible start-object situation into the possible target-object situation, it being possible in this case for the event sequences between two object situations to be initially collected and stored in any desired programming or description language, in particular in any desired but uniform programming or description language. The invention further relates to corresponding devices. The invention further extends to corresponding computer programs and data carriers containing such computer programs, as well as the transmission of such computer programs via the cloud or, for example, the Internet. A new search engine of procedural event knowledge for all adaptive control systems is created.

### TECHNICAL FIELD

The present invention relates to a control method for driving an actuator to transform a start-object situation into a target-object situation, said process being representable by generatable event sequences retrievable from a database to optimize the same. Furthermore, the invention relates to a control system, comprising a computer program product, for driving an actuator in order to implement the control method, an industrial robot system, a vehicle guidance system comprising the control system, a traffic control system, a device and a method for robot-controlled process optimization, a method for normalizing object kinds, and a method for normalizing object situations, wherein all of the listed systems or devices implement the control method according to the invention.

### STATE OF THE ART

Control systems, in particular so-called adaptive control systems, are known from the state of the art. These are also colloquially referred to as controls. In the following, the term control system is replaced by “control” for reasons of readability. Controls and regulations can monitor processes of various kinds and, if necessary, adapt them.

Thus, an adaptive control is known, which is set up to continuously adapt certain operational parameters to changing conditions in order to achieve the best performance of the process. For this adaptation, a finite chain of actions in a time period is necessary, which produces the desired or required DESIRED-object situation from the received sensor data of the analyzed ACTUAL-object situation in a certain space section with the help of the variables to be controlled by the adaptive control.

Each nth action transforms the nth start-object situation Sₙ into the nth target-object situation Zₙ. By a sequence (concatenation) of m actions, the first start-object situation Si is transformed into the mth target-object situation Zₘ. Since the target-object situation is not necessarily changed exclusively via the control, i.e., an action is not necessarily presupposed, the term event is used in the following instead of the term action. So an nth event transfers the nth start-object situation Sₙ to the nth target-object situation Zₙ.

For the adjustment, a target variable is continuously measured, i.e. the current object state (the ACTUAL-object situation) is determined, while a target-state (DESIRED-object situation) is specified for the control. In this way, the control observes the changes in the target variable caused by a change in the input signals and subsequently adjusts its own behavior accordingly.

However, such controls often consume a lot of energy, do not operate at maximum efficiency, and valuable process time is not maximized or wasted on extensive and complex calculations.

This is particularly the case when very complex, non-linear systems are controlled, so that in the case of instability of the complex system, even the smallest changes in the input parameters can be accompanied by significant changes in the target variable. In addition, complex systems sometimes exhibit so-called limit cycles, bifurcations or chaotic behavior instead of achievable fixed points.

Therefore, some adaptive controls have reference models of the system controlled by the adaptive control, which they use to make predictions about the controlled system. Accordingly, these controls have difficulties in responding to states outside the reference model. Furthermore, only local minima are often found during an optimization in the sequence. It should be noted that there are different types of controls. In particular, for complex systems, adaptive controls supported by machine learning (ML) or statistical methods are increasingly being developed. These methods of control are also called “intelligent control”.

Adaptive controls based on statistical methods, such as Bayesian probabilities, require little background information about the controlled system, but are inefficient, meaning that they do not necessarily find optimal solutions and require a lot of time and energy in the process.

Adaptive controls, which are supported by ML, on the other hand, are fast and also efficient in execution. This can be well illustrated by the example of a neural net: A neural net uses a number of input parameters (input) and one or more target parameters (output). Between the input and output layers are interconnected layers of “neurons”. These represent a nonlinear function in which the input values on the previous layers are processed and combined into an output value. The system is then trained with a variety of possible input data to produce the correct output. This requires a corresponding amount of initial training data, which on the one hand must be sufficient to cover the relevant part of the phase space (n-dimensional space of all possible states of the system, where n corresponds to the number of measured parameters) and on the other hand must not show any statistical distortion if possible. During online or offline training, the so-called weightings, i.e. the strengths of the connections between the individual neurons, are varied until the neural net delivers the expected results. The “knowledge” about the domain in which the neural net is applied is thus implicit in the structure of the neural net. While the training is very computationally intensive and thus requires a lot of energy and time as well as powerful hardware in addition to a large amount of training data, the application of the generated neural net for the assignment of a set of input values to a number of output values is comparatively less computationally intensive and thus can be done on less powerful hardware with a manageable expenditure of energy and time.

In both of the latter cases, the known adaptive controls lack the ability to adapt when constraints of the controlled system change, so that the phase space or stabilities in the system also change.

Both options also have in common that after the initial setup of the system, it is only possible to make changes to the control with great effort, especially if the control is in ongoing operation.

In adaptive control, it is known that characteristics can be adapted to the process. However, the complexity of the structure does not grow. The disadvantage is that new, more complex problems can therefore often not be solved optimally or only inadequately. Even after long waiting times (e.g. calculation and search times) with high time and energy consumption, in many cases there is no sufficient new and optimal problem solution.

Frequently recurring problems—without regard to possible complexity—are merely constantly repeated under the previously known constant effort and energy consumption. A disadvantage in the prior art is that the controls have a lack of learning ability.

Classical controls, for example adaptive controls, are very common. A complete replacement of these is very costly in many cases. In addition, the specific embodiment of classical controls is often only adapted to their respective intended use.

### Task

The invention has made it its task to provide an optimized, i.e. more efficient, more energy-saving, faster and/or better structured control method and to design it in such a way that the control method can also be “retrofitted” or “set up” on existing control systems.

In particular, the invention recognizes the need for a high degree of abstraction so that the methods and devices according to the invention are suitable for all purposes, in particular for interplay with all classical control systems, i.e., independent of intended use.

### Solution

The task is essentially solved by adding a knowledge management system to a control method, which comprises event sequences to transform a start-object situation into a target-object situation.

The present task is solved in particular by a control method for driving an actuator for transferring, in particular for convert the actuator from a start-object situation to a target-object situation (i.e. reaching a target-object situation originating from a start-object situation) by means of a control, preferably an adaptive control, comprising
a) Determining (S01) a start-object situation by means of a sensor,
b) Defining (S02) a target-object situation,
c) Determining (S03) an event sequence suitable for transferring the start-object situation to the target-object situation from a set of known (partial) event sequences, in particular partial event sequences (i.e. partial procedures; individual process steps), by
   Iterative search (S03a) of known (partial) event sequences, in particular partial event sequences, comprising the start- and/or target-object situation and/or object situations from partial event sequences of previous iteration steps,
   Selecting (S03b1) at least one event sequence for reaching the target-object situation starting from the start-object situation or building (S03b2) a new event sequence for converting a start-object situation to a target-object situation based on the iterative search of the method found partial event sequences and their concatenations,
d) Driving (S04) of the actuator based on the determined event sequence by the control system.

It is apparent to the person skilled in the art that, in order to define (S01) a task which consists in converting a specific start-object situation into a specific target-object situation with the aid of an event sequence, it is necessary that a start-object situation is first determined by a sensor and then a (desired) target-object situation is predefined and, based on this, a task for converting the object from the specific start-object situation into the specific target-object situation is deduced.

According to the invention, an event sequence is determined from a amount of known (partial) event sequences which is suitable for achieving the target-object situation starting from the start-object situation. For this purpose, a database is preferably used, which is read for the purpose of searching for a suitable solution in the form of an event sequence that is suitable for solving the task. Preferably, the database is suitable for assigning at least the following variables to each other, and in particular for dealing with a weighted combination of these variables:
an identifier of a possible start-object situation,
identifier of the object kinds involved,
identifier of a possible target-object situation,
Identifier of the object kinds involved,
an information about an event sequence, where the event sequence is suitable to convert the possible start-object situation into the possible target-object situation.

The selection (S03b1) of the at least one event sequence for reaching the target-object situation starting from the start-object situation is thereby preferably a solution suitable for the task. Here, the solutions stored in a database are preferably quantified in the form of an event sequence with respect to the aforementioned variables and a solution suitable for the task is selected in the database if a solution suitable for the task has been read (S02) accordingly.

Alternatively, the formation (S03b2) of a new event sequence, in particular a chaining of procedures for building a more complex procedure for reaching a target-object situation is performed starting from a start-object situation on the basis of the partial event sequences found in step S03a and their concatenations. For this purpose, the building (S03b) of a new event sequence, if a solution matching the task has not been read (S02), is performed as n-concatenation from the existing event sequences, preferably comprising the following steps:
Reading (S03b-01) the database to search at least a first and an nth event sequence, in particular searching event sequences from a first to an nth event sequence, where n denotes a natural number, and
   the first event sequence is suitable for transforming the possible start-object situation into a first intermediate object situation, and
   for all natural numbers for which 1<k<n holds, the k-th event sequence is suitable to convert a (k−1)-th intermediate object situation into a k-th intermediate object situation, and
   the nth event sequence is suitable to convert an (n−1)th intermediate object situation into the possible target-object situation

According to the invention, a step of iterating (B02a) over possible intermediate object situations as well as chainings of intermediate object situations, in particular a step of recursive iteration, can be provided, wherein these intermediate object situations are preferably stored in a database, so that a step of reading (B02b) a database for the purpose of searching for suitable event procedures is provided for finding them.

Here, a number n for each possible chaining of the intermediate object situations denotes the length of the respective chaining of the procedures and is given by a natural number greater than or equal to 2. In the step of selecting and chaining procedures to build a more complex procedure, preferably any event procedure is suitable either,
transfer the possible start-object situation into the first intermediate object situation, or
for a k with 1<k<n, convert the (k−1)th intermediate object situation to the kth intermediate object situation, or
(n−1)-th intermediary object situation into the possible target-object situation

For this purpose, preferably in a first step, the computing (B03) of at least one quantitative suitability criterion of the chaining of the procedures ((partial) events sequences) for each chaining of procedures caused by the iteration is performed. Such that the step of selecting one or more concatenations is performed based on at least one quantitative suitability criterion/attribute.

Analogously, it can be provided that the step of selecting an event sequence from an amount of suitable event sequences in step S03b1 is based on at least one quantitative suitability criterion/attribute (as defined herein).

It is understood that thereby the event sequences between two object situations e.g. within a data base can be raised initially and stored in any programming or description language, in particular in any, but uniform programming or description language.

Preferably, the method according to the invention, in particular the control method, may further comprise a step for storing (S05) the determined event sequence. If the determined event sequence is a newly created event sequence, this can be stored in a database as n-concatenation, if necessary, whereby this newly concatenated event sequence is suitable for transferring the possible start-object situation into the possible target-object situation. This has the advantage that when a subsequent event sequence is performed which is identical or at least similar, it can be referred back to in step (c) of the method according to the invention, namely determining (S03) an event sequence.

According to a further embodiment, the method according to the invention, in particular the control method, comprises a first sub-step for determining an event sequence from a set of known (sub)event sequences in a first memory in which successes are stored, i.e. event sequences which are suitable for converting the start-object situation into the target-object situation, whereby by iteratively searching for known (partial) event sequences and selecting a known event sequence or building a new event sequence, in particular building a new event sequence, a (basically) suitable event sequence is determined, and a second sub-step for determining an event sequence from an amount of known (partial) event sequences in a second memory in which failures are stored, i.e. event sequences which are not or only insufficiently suitable for converting the start-object situation to the target-object situation, by searching/determining the event sequence determined in the first sub-step in the second memory or by matching the event sequences determined in the first sub-step with the event sequences determined in the second sub-step, whereby the (partial) event sequences determined in the second sub-step are discarded (cross-checking).

By not discarding failures, these can be used in addition to the variables defined herein, especially quantitative suitability criteria for locating a suitable event sequence. The method according to the invention, in particular the control method or the system for driving an actuator, is thus designed to be at least quasi-learning-capable, preferably learning-capable, so that at least in a first preceeding step, and very particularly preferred, it is possible to completely dispense a comparison of the (entire) determined amount of potentially suitable event sequences on the basis of at least one variable or quantitative suitability criterion (as defined herein). This saves time and reduces the energy required to determine a suitable (partial) event sequence. This saves time and reduces the energy required to determine a suitable (partial) event sequence.

A first memory in which successes are stored is, for example, a so-called success database, i.e. a memory or database in which (partial) event sequences are stored that have led to success in the same or similar combination of start-object situation and target-object situation. A second memory in which failures are stored is, for example, a so-called failure database, i.e. a memory or database in which (partial) event sequences are stored that did not lead to success in the same or similar combination of start-object situation and target-object situation.

According to a further embodiment, the method according to the invention, in particular the control method, further comprises a step for determining forbidden or unpermitted event properties (constraints) within the event sequence to be determined, which is (in principle) suitable for converting the start-object situation into the target-object situation from an amount of known (partial) event sequences, in particular by driving an actuator based on the determined event sequence by the control. Examples of such forbidden or disallowed event properties include an undesired event such as panning, rotating, or bucking of an object due to the inertia of the object, air movements, or vibrations. The determination of such forbidden or unpermitted event properties can be done separately for individual or within individual (partial) event sequences. Thus, (partial) event sequences can be excluded in advance, which seem potentially suitable to convert a start-object situation into a target-object situation, but which are unsuitable due to the presence of a determined forbidden or unpermitted event property. Advantageously, this eliminates the need to match the determined amount of suitable event sequences based on at least one quantitative suitability criterion (as defined herein).

According to a further embodiment, the method according to the invention, in particular the control method, further comprises a step for monitoring a running or a repeating process or a (partial) event sequence, in particular a step for monitoring the recurring start-object situation. An example for this is the activity of a robot at an assembly line, which repeatedly performs the same operation). In this way, despite the (original) determination of a (partial) event sequence that is/was (basically) suitable for converting a repeating start-object situation into the target-object situation, and this (partial) event sequence is thus repeatedly executed (e.g. multiply series-connected), spontaneous changes within an ongoing process, in particular to recurring start-object situations, can be determined and the control method can thus be (independently) adapted. This has the advantage that the occurrence of errors, which are caused e.g. by a (slightly) changed start-object situation, can be prevented and that the external intervention, e.g. by a user or another procedure, can be dispensed with. If, for example, such a spontaneous change is determined within an ongoing process, in particular at a recurring start-object situation, the system for driving an actuator can decide in a step of evaluating this change whether the method according to the invention, in particular the control method, must be run through again in order to determine a new (alternative or adapted) event sequence that is suitable for converting the changed start-object situation into the desired target-object situation.

According to a further embodiment, the method according to the invention, in particular the control method, further comprises at least one step of repeatedly determining a event sequence or a step of repeatedly running through the method according to the invention, in particular, of the control method (according to the steps defined herein, in particular by exclusion of the event sequence that was not suitable for transferring the start-object situation to the target-object situation) if the previously determined and/or executed event sequence was not suitable to convert the start-object situation into the target-object situation. This has the advantage that the system, in particular the system for driving an actuator, does not abort the process of converting the start-object situation to the target-object situation (and, for example, enters an error mode), so that external intervention, for example by a user or another method, can be dispensed with. For example, the step of repeatedly determining an event sequence comprises an upstream sub-step in which the actuator returns to its starting position before the method according to the invention, in particular the control method, is run through again.

According to a further embodiment, the determination of an event sequence according to step (c) of the method according to the invention, in particular the control method, is only partially completed before the conversion of a start-object situation into the final target-object situation is started. This means that with the beginning of the conversion of a start-object situation into the final target-object situation, the determination of the entire event sequence is not yet completed, but the individual partial event sequences are determined successively and concatenated (linked together) step by step to the (entire) event sequence from individual partial event sequences (of the procedural event knowledge, a memory, a database). This has the advantage that after selecting at least one, preferably at least two, very preferably at least 30%, in particular at least 50% of the (partial) event sequence(s) or building one, preferably at least two, very preferably at least 30%, in particular at least 50% of the new (partial) event sequence(s), the conversion of a start-object situation into the final target-object situation can be started via intermediate target-object situations (i.e., the target-object situations that do not yet represent the end of the entire required event sequence), resulting in time and/or resource saving (e.g., required computing power).

Furthermore, it can be provided that after completion of each partial event sequence, preferably at least after completion of every second partial event sequence, very preferably after completion of at least 30%, in particular of at least 50% of the partial event sequences of the entire event sequence, the (correspondingly) expected intermediate target-object situation is compared with the actual intermediate target-object situation. For this purpose, the method according to the invention, in particular the control method, preferably comprises a step of determining an actual intermediate target-object situation (i.e. that of an object situation which describes a state between a start-object situation and a target-object situation and which does not yet represent the end of the entire required event sequence), which in turn can serve as a start-object situation for a further or independent (partial) event sequence by a sensor and matching this determined actual intermediate target-object situation with the determined intermediate target-object situation to be expected of a selected (partial) event sequence or newly formed (partial) event sequence. This has the advantage that when the concatenation of a large number of partial event sequences to achieve the final (desired/aspired) target-object situation, deviations from the aspired event sequence can be identified and compensated/balanced for by making appropriate adjustments. Thus, when a corresponding deviation is determined by the control system, the step of determining an event sequence can be adjusted based on the detected deviation (e.g. in case of successive/partial determination of the entire event sequence, as defined above) or there is a termination of the step of controlling the actuator, which is controlled based on the originally determined event sequence. Such deviations of the actual intermediate target-object situation from the determined intermediate target-object situation based on the aspired event sequence can take place, for example, due to disruptive factors such as friction losses, wearing, external environmental factors, but also after the maintenance/repair of a device and a related, for example, ease of movement of components. Such disruptive factors can subsequently be considered as an event criterion in the step of determining further event sequences.

### General Advantages

By accessing event sequences stored in a memory, in particular a database, the control method according to the invention enables an optimized conversion of a start-object situation into a target-object situation.

In addition, errors that can occur due to an essentially manual predetermination of an event sequence are minimized.

Moreover, the control method according to the invention allows to react to spontaneous changes within a continuous or repetitive process and to provide a new (alternative or modified) event sequence.

Ultimately, the control method according to the invention is designed to learn.

Further advantages can be seen in the description and the embodiment examples.

### DESCRIPTION OF THE INVENTION

ITSF (Intuitive Tacit Solution Finding) is a new method for the aquisition, structured storage, easy retrieval and concatenation of building blocks of procedural event knowledge. This type of knowledge is the most sought after “know how” for multiple processes. The advantage is that the event sequence does not have to be explicated here. That is, the event procedure can be left in the existing programming or description language in which it is collected by a technical entity. The method according to the invention comprises the following (a-g):
a) Aquisition and storage of event sequences: Method for the aquisition and structured storage of procedural event sequences as the connection of a start-object situation with a target-object situation. Each of these stored event sequences is a small building block of the procedural event knowledge.
b) Fast retrievability of event sequences: The initially collected event sequences are stored in a structured way in the list of event procedures and can be retrieved very quickly and easily via their start and target-object situation.
c) Normalization of object situations: actual objects are first assigned to more general object kinds (normalization of object types). Then, these object kinds are combined into an object situation within a limited space section and normalized using the list of object situations.

Preferably, the assignment of actual objects to object kinds takes place on the basis of information collected by sensors. Particularly preferably, the assignment of actual objects to object kinds takes place on the basis of the sensors and the processing of the data in an adaptive control.
d) Procedural event sequences: Between the currently analyzed start-object situation and the required target-object situation there is always the sought event sequence as a connection of these two object situations and it is stored in the list of procedural event sequences.
e) Concatenation of event sequences: If there is no entry in the list of known event procedures for the requirement of a start- and target-object situation, a concatenation of event sequences is searched for, which contains the start-object situation at its beginning and the searched target-object situation at its end. Each member of this concatenation chain is connected via its normalized target-object situation equal to the start-object situation of the next sequence that fits into this connection. If this concatenation is not found within the safety period which depends on the purpose of the control, the old adaptive control or a manual procedure must be called to initially and for the first time raise the previously unknown event sequence. As described earlier, an event represents a transition from a start-object situation to a target-object situation in a particular space section. These states can be interpreted as nodes in a graph, thus the events can be interpreted as edges between the states. Accordingly, all states that can be transformed into each other can be summarized as one graph. Depending on whether events are reversible, they can be represented by directed or undirected edges. If an event sequence is now sought which is suitable for transferring a start state to a target state, simple routing algorithms such as A* or Dijkstra can be used. The graph can be regularly optimized for faster routing. Various graph databases that store information in graphs are already known from the prior art. These are optimized according to technical criteria. Further optimizations can be made, for example, by forming so-called contraction hierarchies. For this purpose, the entire graph is analyzed and virtual edges, which store the information about the fastest paths between two points, are generated. Thus, the search of an event sequence from a start state to a target state can take place extremely fast. Here, the terms “procedure” and “event” are used equivalently.
f) Ongoing ITSF operation in a database: Intuitive Tacit Solution Finding is a useful addition and effective relief of known adaptive controls. The old control system runs in the background and, if necessary, makes fine corrections to ITSF procedures. It is also used for completely unknown object situations and for the collection of completely new event sequences.
g) Constant fully automatic further development: Due to the continuous concatenation of event sequences even in the idle or sleeping state, more and more complex event procedures are automatically created in the list of procedural event sequences. Thus, the complexity grows and ever larger, more strategic tasks can be taken on. However, the first procedures with their finer granularity still remain. Both serve to extensively relieve and accelerate the old adaptive control. In the idle or sleeping state of ITSF, all concatenations previously possible in the list of procedural event sequences are also generated. Both serve to extensively relieve and accelerate the old adaptive control. In the idle or sleeping state of ITSF, all concatenations previously possible in the list of procedural event sequences are also generated.

ITSF—Intuitive Tacit Solution Finding is a new method for the acquisition, structured storage and easy locatability of procedural event knowledge. This knowledge is not so easy to describe explicitly, mostly unconscious (tacit) and therefore needs a special treatment when processing it. With this new way of dealing with it, the old problems of treating the most important component of tacit knowledge can be thoroughly solved. But what distinguishes knowledge in general from information or data?

Data are first of all only purely syntactic records of circumstances or events. They are capable of flipping new switches, as it were, at another point in the processing chain. However, these data with their semantic aspects only become information when we relate them to our already existing semantic knowledge building. Only then does data acquire meaning and become real information for us. They can verify, falsify or also extend the already existing semantic knowledge. However, this information only becomes knowledge when we subsequently classify it correctly in our semantic knowledge building and link it semantically many times.

The most basic two categories of physical reality around us are objects in space as well as events in time. This probably most significant distinction thus always also conditions the two actual basic types of our knowledge according to their direct relation to the physical reality around us and is therefore the basic segmentation into: declarative object knowledge and procedural event knowledge.

Described in detail by Theo Mulder 2006 (Mulder, Theo (2006)): The adaptive brain: on movement, consciousness and behavior. Thieme, publisher C. H. Beck). Declarative object knowledge refers to local objects in space that can be described very extensively and unambiguously explicitly with all their properties. They are always located in local object situations with multiple, sometimes very extensive relationships of these objects among each other in a section of space. Procedural event knowledge, on the other hand, refers to sequential or parallel events in a time section, which in their many sequential or parallel steps are already much more difficult to describe explicitly and are very often stored unconsciously (tacitly), i.e. implicitly in their nature and sequence in the brain. This unconsciousness refers especially to their duration and their energy expenditure.

The clear unconsciousness is nevertheless often accompanied by a complete self-evidence of this implicit knowledge, which we actually only ever become fully aware of when a process or an employee in a corresponding position fails and then the necessary activity can no longer be carried out properly due to the lack of procedural knowledge. Basic examples of tacit knowledge are such actually very simple and yet difficult to describe activities like maintaining balance while riding a bicycle, the very special tool handling in arts and crafts, or even entire sequential work processes. In particular, the explication, segmentation and subsequent retrieval of procedural event knowledge is still a really serious problem for many companies and technical institutions today.

In order to be able not only to react, but also to act meaningfully in a changing reality, every intelligent, adaptive control today needs a well-structured knowledge management system with which it can learn from past knowledge and experience. It's no longer just about collecting data, it's about analyzing, categorizing and trackability of knowledge building blocks. This means that control technology and knowledge management must work ever more closely together. For this purpose, it is necessary to collect the two most important types of knowledge separately, to store them in a structured way and thus to be able to retrieve both easily, quickly and correctly. The fast and correct retrieval of knowledge building blocks of procedural event knowledge is the main goal of Intuitive Tacit Solution Finding—ITSF.

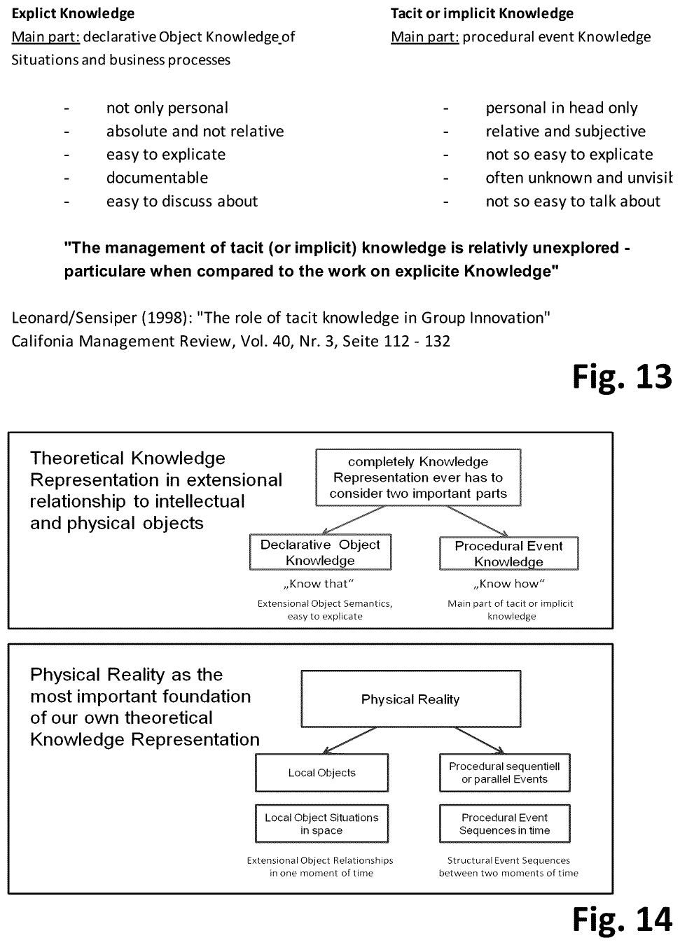

For example, the professional knows from “The role of tacit knowledge in Group Innovation,” California Management Review, Vol. 40, No. 3, pp. 112-132, that “the management of subconscious information is poorly researched, especially when compared to the work regarding explicit knowledge (see FIG. 13).

On the surface, we actually take it for granted that we can articulate all the knowledge we believe we possess. Only on closer consideration do we realize that for all this knowledge and its articulation, at least a whole lot of unconsciously used basic knowledge, common models of thought, abilities and skills, such as those of speaking, are necessary, of which, unfortunately, we rarely really become fully aware and which we can therefore also articulate only with difficulty or not at all.

Polanyi already formulated this in 1966: “( . . . ) that we know more than we know how to say.” (Polanyi, Michael (1966): Implicit knowledge. (The tacit dimension.). Deutsch Suhrkamp 1985).

There exists a very large area of knowledge which is difficult to articulate and which refers to sometimes very complex processes like our movements or to highly complex external events. In logical contrast to local objects in space there are always the sequential or parallel events in time. This distinction is the most essential division in our physical reality and for this reason also the most essential division of our ways of knowing about this physical reality. Nevertheless, nobody seriously talks about it today, so self-evident this fact simply seems to us. But only the examination of the inner relation of these two basic kinds of knowledge to each other and their meaningful linkage becomes interesting. In all sequential events are always also many local objects involved and only in our purely theoretical cognition and experience of these processes the two can be separated. This division is one of our greatest mental achievements, but unfortunately it is hardly appreciated today. However, in any case the fact remains that sequential events in time are much more difficult to describe than local objects in space. Moreover, events are always connected with a certain input of force or energy in time, which we can describe and convey quantitatively verbally very difficult.

Everything starts with the recognition and description of local objects in a space section, their manifold properties, their location and manifold spatial relations to each other. The actual objects are first assigned to more general types of objects, which depend on the purpose of our spatial observation. Such a purpose can be, for example, autonomous driving in road traffic or, in contrast, the recognition of workpieces and their position to each other when using industrial robots. Defined object situations then arise from the assignment of recognized objects to object kinds and the position of these object kinds in relation to each other in a space section.

In road traffic, for example, object kinds can occur such as pedestrians, cyclists, cars, trucks, traffic signs, road boundaries, walls or even one's own position in a space section. In the work of industrial robots, object kinds are more likely to occur such as cylinders, cuboids, cubes, blanks or the finished product. After the recognition of the local objects, the assignment to object kinds and their position, the recognition of the entire object situation in a room section follows. Both the recognized object kind and the recognized object situation are compared with all already stored object kinds and object situations and can verify or also extend these two lists. If known object kinds or object situations occur, they are simply assigned to the already known entries of both lists. For previously unknown object kinds or object situations, new entries are created in both lists (normalization of object knowledge). This has already been collected, declaratively described and stored very well for a long time with the AI technologies available today. Mostly today, the collected data is then pumped into large datalakes, from which an analysis of the unstructured data must be performed very laboriously.

It is much more difficult with the collection of procedural event knowledge. Here, we can establish a sufficient description and good retrievability only by relating it to declarative object knowledge. In reality, events always connect an actual object situation with a desired-object situation, i.e. we store procedural event knowledge as the connection of a start-object situation with a target-object situation as an event sequence. For the connecting event, the necessary description must always be recorded with the necessary change of position and the energy and time required for this. This is quantitatively mostly unconscious to us (tacit). In addition to the recognized actual object situation, the controller must always have a required desired-object situation. In autonomous driving, for example, this consists of parameters such as the required minimum distances to other types of objects or a target speed, direction and destination on the road.

The two main categories of physical reality are shown in FIG. 14.

When using industrial robots, the desired-object situation consists, for example, of the correct position of a workpiece that has previously been assigned to an object kind and an actual-object situation in a specific space section. Simplifications can be achieved here, for example, if each object kind is given a specific color beforehand. The industrial robot then creates the required desired-object situation from the detected actual-object situation. This can be done by repositioning as well as by correct editing. Between the actual-object situation and the desired-object situation there is always a certain procedural event sequence with a certain time duration and a certain energy expenditure. After the storage of the object situations these event sequences can be raised then by unique pre-exercising and storing for the first time. At the beginning thus always the list of sequential event procedures must be filled initially. The start ID is the recognized actual object situation and the target ID is the required desired-object situation. The procedural event sequence is then recorded correctly and perfectly structured in the new list of procedural events as content via both and can thus also be found again. This content can be present in any programming or description language. However, a lot of other useful information can also be collected and stored for the event sequences.

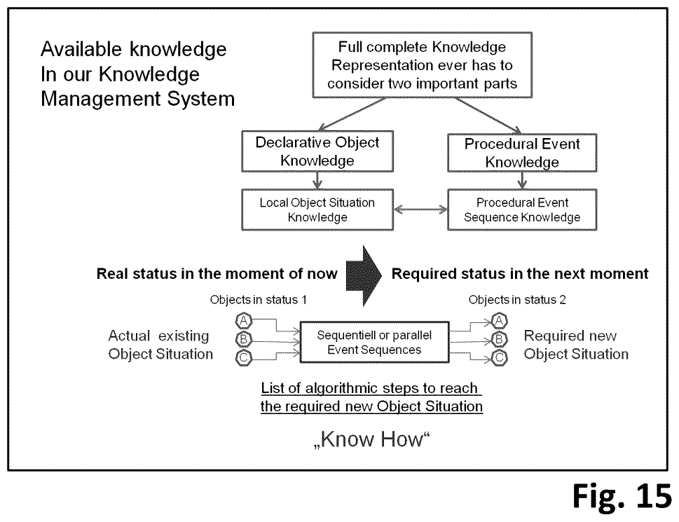

In addition to the start and target ID of object situations, the content of the event sequence and the necessary energy of the drive of a car or the access of the tools of an industrial robot must also be stored for the list of procedural events. In addition to these basic data of a procedural event, we are of course absolutely interested in the duration and especially the degree of success of a procedure to reach a desired-object situation. The degree of success should always be divided into levels of evaluation and clearly reflect both success and failure. Thus, for future applications of this event procedure to achieve a desired-object situation, this sequence can be particularly preferred or avoided in principle. The connection of procedural event and declarative object knowledge is shown in FIG. 15.

As structured as the procedural event knowledge is recorded here, it can also be retrieved easily, quickly and correctly. No unstructured datalakes and no Big Data scientists are needed for the evaluation, which do not exist anyway in the case of autonomous driving or the use of industrial robots in the on-site production process. In the simplest case, an entry already exists in the list of procedural event sequences that contains the correct actual and target ID of the object situations with a high evaluation of the probability of success as well as the necessary time duration and energy. This is then selected and executed based on the comparison of these parameters. If this is not the case, a chaining of several event procedures must be searched for in the event list. Here, the recognized actual ID(a) of an object situation a becomes the starting point and x1 to xn further procedures with target ID(a to xn)=start ID(x1 to z) are linked until the desired target ID(z) of the required desired-object situation z is reached. In addition to the important rating of success, the shortest time duration and the lowest energy expenditure are used as further criteria for the selection of the event sequences. Of course, this is only done until at some point a specific safety time period, which is quite important for the particular application, is exceeded. This depends on the purpose of the application.

The available safety time span can of course be quite different for autonomous driving than for the work of industrial robots. If a suitable chaining is found within this time span, which contains the actual ID(a) of a recognized start-object situation at its beginning and the target ID(z) of the desired- or target-object situation at its very end, this chained event procedure is selected and executed. For all partial procedures of this, there should of course be as high a probability of success as possible. In addition, the evaluation and selection of similar matching procedures naturally always includes the comparison of the stored time duration and its energy expenditure. If such a chained procedure is found, it is executed and then a new entry for this procedure is created in the list of event sequences. Over time, chaining creates an ever-increasing complexity and evolution of new event procedures, while maintaining the fine granularity of the initial procedures.

If no such chained event procedure is found, a new procedure must be raised. This must, of course, first be pre-exercised manually or by the old adaptive control, i.e. both for autonomous driving and for the use of industrial robots, the manual or the old machine control system must be adopted for a short time. This then usefully supplements the list of existing event procedures. The fine granularity of the old procedures is retained, but the complexity of new concatenated procedures, on the other hand, continues to increase in a fully automated manner. For future applications, I would like to call the fast and correct retrieval of procedural event knowledge “Intuitive Tacit Solution Finding—ITSF”. Intuitive because the solution finding is not done by computation but intuitively by searching in the memory of existing sequential event procedures and Tacit because this search is unconscious to us. It is no longer only about the declarative object knowledge related to the properties of objects, object kinds and object situations as the “Know That”. It is about the procedural event knowledge, which is difficult to explicate and mostly completely unconscious, as the often sought “know how” for quite a lot of types of technical and organizational applications.

With this kind of processing of procedural event knowledge it becomes possible for us to intuitively and unconsciously (tacitly) raise procedural events, retrieve them and use them in the processing of a control without having to describe these events in a complicated explicit way. By calling a recognized actual-object situation and a required desired-object situation, we can retrieve from the facility a defined procedural event of certain granularity, which has already been performed in the past as a connection of these two object situations as successfully as possible and in the required time. Within the known world of this control facility, predictions about the success, time duration and energy expenditure of a procedure to be used in the future thus also become possible.

These can be compared with the available safety time span until an action is necessary and the available energy supply of a technical device. This is exactly what is still missing in detail in all adaptive control systems known today. Likewise, of course, it can also be used in completely new knowledge management systems of a company, where, for example, the correct storage and retrieval of organizational procedural event knowledge as “know how” is involved. The advantage clearly lies in the no longer necessary explication of procedural event knowledge (tacit) and the extremely short reaction time due to the new intuitive retrieval, which makes lengthy calculations of a new procedure unnecessary. Instead of event sequences, of course, a wide variety of algorithms can be collected, stored, and concatenated for further processing in modern computer facilities. The advantage is still clearly that any different programming or description language can be used for the procedures or for the algorithms as the content of the event procedure list. It must, of course, be consistent in each separate facility.

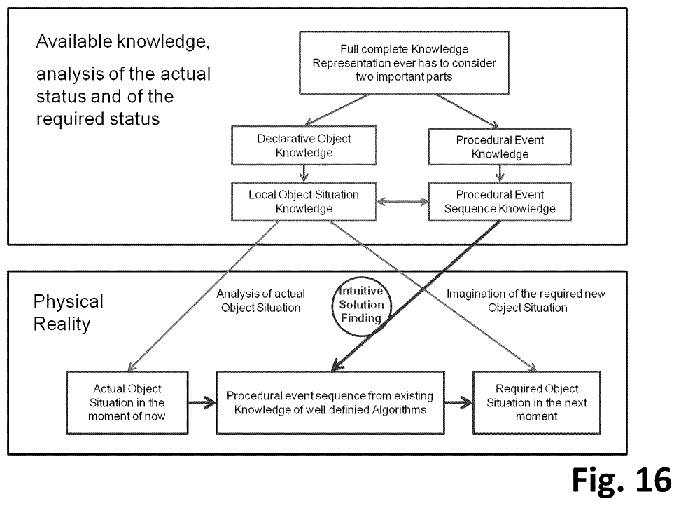

Intuitive Tacit Solution Finding (ITSF, see FIG. 16) is thus a new development that usefully supplements previously known control systems, e.g. in autonomous driving in the automotive industry or in the use of industrial robots in many branches of industry. It can be built directly on top of known control processes and extends them over time, especially in more strategic decision-making processes, without the need for human intervention. By properly combining local object knowledge and procedural event knowledge, we enable ourselves to process the most important two types of knowledge very fluently for better control of diverse technical equipment. In addition, the intuitive and non-explicit treatment of procedural event knowledge implies a high speed advantage over all the existing processing, such as previous calculations, computations and the old downright desperate attempts at explication of this type of knowledge.

Procedural event knowledge is the most important type of knowledge used for control systems, but until now it could not be handled correctly enough. By their meaningful and correct connection with the already known declarative object knowledge we receive for the first time the possibility to raise both correctly, to process and again find. In particular the newly developed chaining of many already known event procedures lets us find here also completely new and strategic solutions for suddenly arising requirements or problems to be solved in a flash, which did not exist so far in such a way. This processing can therefore rightly be called creative in the generation of new approaches to solutions. Intuitive retrieval also always requires much less time than the complicated, detailed calculation and computation of a required solution. The (tacit) treatment of procedural event knowledge, which is hidden to us, also saves its complicated explication. With this essential addition of ITSF, adaptive control devices become decisively smarter, faster and more efficient.

For the processing of procedural event knowledge, at least the following information must be recorded, stored and linked as knowledge building blocks. Only then does fully automated handling of the two most important types of knowledge and rapid retrieval become possible.

List of Procedural Event Sequences in a Time Segment

| | |
|---|---|
| Start OS ID | Actual OS ID of the analyzed start-object situation |
| | in the present |
| ES ID | ID of the stored event sequence, is assigned by |
| | machine |
| Event Sequence | Designation of the event sequence, is assigned |
| | automatically |
| ES Content | Content of the event sequence, can be in any |
| | programming or description language, over time |
| | a higher degree of complexity automatically |
| | arises, but the fine granularity of the old procedures |
| | remains. But must be uniform. |
| Success Rating | Degree of success of the event sequence in previous |
| | implementation |
| Duration | Duration of the procedural event sequence |
| Effort | Force or energy expenditure of the procedural |
| | event sequence |
| Target OS ID | target OS ID of the required target-object situation |
| | in the next moment. |
| Timestamp | Date and time of the first recording |

List of Normalized Local Object Situations in a Space Segment

| | |
|---|---|
| Object Kind IDs | Object kind IDs involved in the local object situation |
| Object Situation | Designation of the object situation, is assigned |
| | automatically |
| OS Content | Content of the local object situation, can be in any |
| | programming or description language, but must |
| | be consistent |
| OS ID | ID of the local object situation, is assigned |
| | automatically |
| Timestamp | Date and time of the first recording |

List of Previously Assigned Object Kinds (Normalization of Object Kinds)

| | |
|---|---|
| Object Kind ID | Designation of the object kind, is filled automatically |
| Object Kind | Content of the object kind, can be in any programming |
| Content | or description language, but must be consistent |
| Object Kind ID | ID of the object kind, is assigned automatically |
| Timestamp | Date and time of the first recording |

The search for the involved object kinds is done via the Object Kind Content. The linkage between the object kinds involved and the object situations is made via the Object Kind IDs. The search for the correct object situation is first carried out via the Object Kind IDs involved and then via the Object Situation Content. From there, the correct event sequence is called using the Start and Target-Object Situation IDs.

The old adaptive control used runs in the background and makes fine corrections if necessary. While the old control generates solutions every 1-12 milliseconds, it is sufficient for the more strategic or completely new decisions of ITSF to make a decision once every tenth of a second for one or more event sequences, which then run with a specific duration. These called known event sequences thus in turn substantially relieve the old adaptive control. The available safety period for solution finding is an example here and always depends on the purpose of using ITSF. In the idle or sleep state of ITSF, all possible still missing concatenations of procedural event sequences are generated and added to the list of procedural event sequences.

Possible applications arise in all fields where adaptive controls are already in use, such as industrial robots, autonomous driving or robotic process automation for computer equipment. The skilled person will also recognize from this that at least one means is provided which is set up to execute at least one event of the determined event sequence.

In the following, an industrial robot will be described as a possible application example. Industrial robots are defined “as universally applicable (flexible) automatic motion machines with multiple axes, whose movements are freely programmable in terms of movement sequence and paths or angles.” Older industrial robots use fixed programming without any sensors. For adaptive controls, on the other hand, it is important that, in addition to the programmable manipulator, good sensor technology and learning-capable control are used to determine the current actual-object situation(a) and to check the result of the action in a new desired-object situation(z). Up to now, this learning capability has only been established at the level of the collected position data. Today, increasingly complex tasks in the production process require that completely new procedural knowledge building blocks are collected, processed and then also used practically here on a higher level of abstraction and processing instead of the simple position and movement data. The most important difference lies in the semantics of the procedures, which no longer need to be explicated, and in the complexity of the processing of ITSF.

When programming industrial robots, we distinguish between online and offline programming. While offline programming takes place independently of the real robot in a suitable development environment, online programming is directly connected to the real robot environment. ITSF, in particular an ITSF event sequence list, can be used very well in the online programming of an adaptive robot device. There are 3 variants for online programming: Teach-In, Master-Slave and Play-Back. All 3 variants have in common that the programming is done by pre-exercising the desired movements and manipulations. This means that the event procedure list of ITSF can be initially filled in parallel to the adaptive control with a suitable sensor system. This then expands completely independently in the course of the use of this adaptive industrial robot. Furthermore, the complexity of new event sequences in this list increases fully automatically over time due to the concatenation of existing event procedures. In a preferred embodiment of the invention, this is not stored locally but in the cloud, extremely extensive information of the entire system integrated in ITSF is available to all the automata involved. Depending on the degree of standardization, all controllers of a type, a manufacturer or an industry can then access this database of procedural event knowledge. Thus, a search engine of procedural event knowledge is created.

Intuitive Tacit Solution Finding can be integrated as an additional function in any adaptive control of e.g. industrial robots and implemented subsequently. Due to the continuous concatenation of already existing event sequences, it takes over more and more complex, later more strategic or even completely new creative functions in the course of time when finding solutions for current and sometimes completely new tasks. While the old adaptive control runs in the range of 1-12 milliseconds, for ITSF it is sufficient to make a decision about once every tenth of a second. The selected process then runs for the entire known duration of the relevant event sequence. ITSF thus relieves the old adaptive control system in particular more and more over time. Of course, the adaptive control continues to run in the background and is used for completely new and unknown sequences for one-time pre-execution of completely new procedures or, if necessary, for important fine corrections during the entire work and runtime of ITSF event procedures.

Autonomous driving will be described as another application example. According to the specifications of SAE (Society of Automotive Engineers) and those of the market leader Bosch, autonomous driving in road traffic is divided into 5 different levels of automation of this autonomous driving process: SAE-L1 Driver Assistance Systems, SAE-L2 Partially Automated Driving, SAE-L3 Conditionally Automated Driving, SAE-L4 Highly Automated Driving, SAE-L5 Fully Automated Driving.

All these 5 levels require, in addition to the use of extensive sensor technology in the driving process (e.g. multifunction cameras and radar), a very fast adaptive control, which determines the necessary correct event sequence as a connection of the current object situation(a) with the required target-object situation(z). The difference lies in the amount of event procedures that lie between the two new object situations. Therefore, for the smooth automatic operation of this adaptive control, it requires the three action components Sense, Think, Act. “Today's assistance and semi-automated systems support the driver, but they do not replace him. These include, for example, the Stop&Go Pilot or the Active Lane Change Assistant. Autonomous systems, on the other hand, will go one step further in future cars: the driver will become a mere passenger in the future. The difference between automated and autonomous driving is also legally significant.” By deploying ITSF procedures in the cloud and making them available to all road users, a huge new field can be opened up here.

In Autonomous Driving, online programming of ITSF, or the acquisition of the ITSF event sequence list, takes place by the manual or by the adaptive control of the vehicle, i.e. event sequences are acquired, processed and stored that have already been successfully used in the Autonomous Driving process in the past. These can be concatenated into increasingly complex event sequences at all 5 levels of Autonomous Driving and thus develop further fully automatically. This then results in a higher level of Autonomous Driving. Via the cloud, this information is fully available to all road users and a huge collection of important knowledge modules about all road users takes place.

In contrast to the computation and calculation of the necessary event procedures by the adaptive control, ITSF determines the next event sequence by intuitively searching the procedural event list resulting from the past work of the old control. In addition to the ever-increasing workload of adaptive control, more and more complex event sequences are created here, and their concatenation over time enables more strategic or even entirely new and creative solutions to problems that suddenly arise. Any redundancies must be eliminated. The complexity is constantly increasing and must absolutely be linked to geodetic data for autonomous driving right from the start. In the end, it is sufficient to enter the starting point and the destination point of an already known drive and the most autonomous drive to the target-object situation is made. The cloud opens up huge opportunities for all traffic participants.

Robotic Process Automation will be described here as another application example. From taking over monotonous data entry tasks to automating responses to customer service requests, Robotic Process Automation (RPA) will enable employees in finance, for example, to save a lot of time on repetitive, labor-intensive tasks and enable value creation within banks on an industrial scale. RPA has revolutionized the banking sector by enabling banks to perform back-end tasks more accurately, quickly and efficiently without completely overhauling existing operating systems and processes. Again, all RPA participants can be connected through the cloud.

In the simplest case, the object situation(a) is the desktop of a desktop PC available after startup. The event sequences are generated by the human-machine interfaces with mouse and keyboard. RPA records these and checks the resulting object situation by comparing it to the known desired-object situation(z) at the end of the RPA procedure. With ITSF, these can then be concatenated in an ITSF event sequence list and thus fed to larger automation procedures. ITSF can be easily and unobtrusively installed on the same PC environment without the need to replace old applications. ITSF learns from the stored procedures of RPA and constantly builds new larger process chains. In the end, the call of a target or desired-object situation is sufficient to run a process chain fully automatically. The sensor technology here lies in checking the degree of achievement of the target or desired-object situation. Without this check, RPA is blind and must be controlled manually. These process chains can be stored in the cloud for all participants in a company.

ITSF can be used for Robotic Process Automation. Unlike other traditional IT solutions, RPA allows companies to automate at a fraction of the cost and time previously required. RPA is also non-intrusive and leverages existing infrastructure without disrupting underlying systems that would be difficult and costly to replace. With RPA, cost efficiency and compliance are no longer an operational cost, but a byproduct of automation.

If RPA is supplemented by ITSF, new and increasingly complex solutions can be created fully automatically from a large number of RPA procedures. ITSF does not require a different environment, but can also run on the PC environment without any problems. In addition to the PC deployment, deployments in the cloud, on smartphones and tablets are also planned here in the future. RPA automates processes on the PC. ITSF enables increasingly complex process flows on all end devices for all users of a company. The current start- or actual-object situation(a) is automatically analyzed. Within the known world of the controller, only the desired target-object or desired-object situation(z) has to be requested. As a result, the connected and sometimes very complex ITSF event procedure is called and executed. Finally, the desired-object situation achieved is compared with the desired result and the degree of success, duration and energy required for the next call of this event procedure are stored, preferably in a company's own cloud. Through the concatenation of procedures, the degree of automation increases constantly and fully automatically.

According to a further embodiment, a step of the method according to the invention, in particular of the control method, comprises selecting an event sequence from a set of suitable event sequences on the basis of at least one quantitative suitability criterion. Thereby, in an additional sub-step, a (partial) event sequence can advantageously be linked to a quantitative suitability criterion, while a further (partial) event sequence can be linked to the same or a further quantitative suitability criterion. Particularly preferably, (partial) event sequences that have already been suitable in the past for converting an identical or at least similar start-object situation into a target-object situation are stored in a memory, in particular a first memory, for example in a (success) database. Thus, during the concatenation of (partial) event sequences for determining a suitable event sequence, it is advantageous to fall back on (partial) event sequences, in particular on partial event sequences, which were already suitable for transferring an identical or similar start-object situation into an identical or similar target-object situation. The quantitative suitability criteria can be weighted differently. Advantageously, optimized, in particular time-, energy-, effort- and/or success-optimized (partial) event sequences can be selected as a function of the desired suitability criterion to be optimized.

In a further development, an effort and/or cost indicator is used as a quantitative suitability criterion. Advantageously, a process or a (partial) sequence of events can be optimized with regard to the effort to be used.

In a further embodiment, energy consumption is used as a quantitative suitability criterion. Thus, the control process or the control can be advantageously optimized so that it can be carried out as energy-efficiently as possible. This is particularly relevant for processes which are characterized by the occurrence of a so-called peak power (a maximum power required within a process), since a (partial) event sequence can thus be determined in which the peak power is reduced and/or a uniform distribution of the power can be set.

In a continuing education program, a success indicator is used as a quantitative suitability criterion.

In a preferred embodiment, the determined sensor data is normalized before it is used to determine the start-object situation. An important goal of normalization is the elimination of redundant information. Thus, after normalization, there are advantageously no more data duplications and each piece of information is stored in only one place in the database. The elimination of duplicates increases the consistency of the database.

In a further embodiment, the method comprises a step for storing the determined event sequence. This allows determined event sequences to be pooled in a database. The more determined event sequences there are in the pool, the easier it is for the transfer of a (new) start-object situation into a (new) target-object situation, since a suitable event sequence can already be found that is either identical or similar to an optimal new (partial) event sequence. Hereby, the computing effort can be minimized, which makes the procedure more efficient.

In a preferred embodiment, the method according to the invention, in particular the control method, comprises a step for aborting the determination of an event sequence if no suitable event sequence for achieving the target/achieving the target-object situation can be determined and/or if the control cannot perform the step for determining an event sequence. The control cannot perform the step for determining an event sequence, for example, if there is no identical or similar (partial) event sequence or if there are at least two (partial) event sequences with respect to the consideration and weighting of at least one quantitative suitability criterion that are suitable for converting an object situation into an (intermediate) target-object situation. This has the advantage, for example, that the method does not remain “trapped” in the step of iterative searching and/or a step of signaling indicates to a user or another method or system for control that external intervention is required.

In a further embodiment, the abort step is automatically aborted after a predefined period of time, which can be freely selected by the person skilled in the art, has elapsed. Advantageously, this prevents the downtime or idle time from being too long. In order to nevertheless transfer a start-object situation into a target-object situation, the termination can be used to select an event sequence that is at least similar to a sought optimal event sequence. Thus, it can be advantageously achieved that no too long downtime or idle time occurs.

A further embodiment comprises a step of adding a (partial) event sequence newly determined by the control to the amount of known (partial) event sequences, in particular in a memory. This expands the above-mentioned memory (pool) of available (partial) event sequences, in particular in a success database, whereby advantageously a higher probability is given that a suitable (partial) event sequence is found which converts a start-object situation into a target-object situation.

In a further embodiment, the method further comprises a step of automatically supplementing the known event sequences with possible additional event sequences while the method is not being used to reach a target-object situation.

Furthermore, the invention comprises a system for driving an actuator for transferring a start-object situation to a target-object situation by means of a controller, in particular for transferring the actuator from a start-object situation to a target-object situation by means of a controller, preferably an adaptive controller, comprising:
a) Input means for receiving (S01) a start-object situation from a sensor,
b) Input means for receiving (S02) a target-object situation,
c) Computing means for determining (S03) an event sequence suitable for transforming the start-object situation into the target-object situation from a set of known (partial) event sequences by
   Iterative search (S03a), preferably in a database, of known (partial) event sequences comprising the start- and/or target-object situation and/or object situations from partial event sequences of previous iteration steps,
   Selecting (S03b1) at least one event sequence for transferring the start-object situation to the target-object situation or forming (S03b2) an optimized event sequence for converting the start-object situation to the target-object situation on the basis of the (partial) event sequences found in the partial step of the iterative search and their concatenations,
d) Output means for outputting a control signal for driving (S04) an actuator based on the determined event sequence by the control

In a further embodiment, the system includes means for detecting known sequences of events and/or known object situations and/or associations between them.

In an alternative embodiment, the system comprises a means for storing at least one success indicator and/or at least one time duration indicator and/or at least one effort indicator and/or at least one cost indicator and/or at least one relevant time for event sequences.

According to a further embodiment, the system for driving an actuator further comprises a means for monitoring an ongoing or a repeating process or (partial) event sequence. Hereby, despite the (originally) successful determination of a (partial) event sequence which is/was (in principle) suitable for transferring a repetitive start-object situation into the target-object situation, and this (partial) event sequence is thus repeatedly executed (e.g. connected several times in succession), spontaneous changes within a running process can be determined and thus the control method can be adapted. This has the advantage that the occurrence of errors, which can occur due to a (slightly) changed start-object situation, can be prevented and the external intervention, e.g. by a user or another procedure, can be dispensed with. If, for example, such a spontaneous change is determined within an ongoing process, a system for driving an actuator can decide in a step of evaluating this change whether the method according to the invention, in particular the control method, is run through again in order to determine a new or adapted event sequence which is suitable for converting the changed start-object situation into the desired target-object situation.

In a preferred embodiment, the invention comprises a computer program product comprising instructions which, when the program is executed by a computer, cause the computer to implement the determination of an event sequence for converting a start-object situation into a target-object situation. In doing so, the computer program product may perform an iterative search and/or select an event sequence and/or combine a (partial) event sequence into concatenations. Advantageously, a computer program product enables a fast realization of these steps, preferably in the range of milliseconds to seconds. Further advantageously, the computer program product can be quickly adapted to different circumstances (different start/target-object situations). Preferably, the computer program product is stored on a computer-readable medium, which further preferably is either comprised by a computer and/or can be exchanged between computers.

The invention further relates to an adaptive control comprising a computer described above.

In a further embodiment, a computer program product comprises instructions that, when the program is executed by a computer, cause the computer to human-readably represent results of a computer program, or to convert the results into another (data) format that can be human-readably represented by another computer program product, and/or to cause the computer program product to implement the method according to any of the four preceding claims.

Furthermore, the invention relates to at least one industrial robot system comprising a control system defined above, a sensor for determining a start-object situation, and an actuator for transferring a start-object situation to a target-object situation.

In addition, the invention relates to a motor vehicle guidance system, which is preferably adapted to a motor vehicle, in particular a driver assistance system or system for semi-automated or autonomous driving, comprising a control system described above, a sensor for determining a start-object situation, and an actuator for transferring a start-object situation to a target-object situation.

Furthermore, the invention comprises a traffic control system suitable for implementing the control method according to the invention, wherein the traffic control system comprises:
a variety of motor vehicles, as well as per motor vehicle:
   a first communication interface, in particular a wireless interface, which is set up to communicate with other motor vehicles in a first immediate environment of the motor vehicle,
   a second communication interface, in particular a wireless interface, in particular by means of a cellular connection, in particular 5G, for communication of all vehicles with a server.

Furthermore, the invention comprises an apparatus for robotic process optimization, comprising:
a human-machine interface, preferably a desktop environment, preferably a desktop environment of a workstation PC comprising mouse and/or keyboard,
a sensor or a sensor system which is set up to record an object situation of the man-machine interface,
a comparison unit which is set up to compare at least two object situations,
a memory and a CPU, which are arranged to execute the control method according to the invention,
wherein the memory can in particular also be provided in a cloud and comprises a database set up for said methods, wherein a robot can communicate with the cloud via a data interface, in particular wireless data interface, in particular by means of a cellular connection, in particular 5G. Communication via a mobile radio connection, or a radio standard such as WLAN, Bluetooth, for example, advantageously allows data, in particular event sequences, to be transmitted without the need for a cable connection.

In addition, the invention also relates to a method for robot-controlled process optimization, which comprises the control method described above as well as a control system described above, wherein in particular the start- and target-object situations may denote virtual situations, wherein a system is provided at least comprising
a human-machine interface, in particular a desktop environment, in particular a desktop environment of a workplace PC comprising mouse and/or keyboard,
a sensor system which is set up to record an object situation from the man-machine interface,
a memory and a CPU for the processing, and wherein the method further comprises at least one step of a comparison, wherein two necessary object situations are compared with each other.

wherein the method further comprises at least one step of a comparing step, wherein two necessary object situations are compared with each other.

Further, the invention relates to a method for normalizing object kinds to support the control method defined above as well as a system defined above, in particular by acquiring and/or using declarative object knowledge, further comprising the following steps:
Initiate a spatial view,
Establish a purpose of spatial consideration in the form of at least one indication of purpose of the spatial consideration,
Detection of at least one actual object in a section of space,
Assigning a specific object to an object kind, in particular to a more general object kind, depending on at least one purpose of spatial observation, and
Saving the assignment of the actual object and the type of object using a database.

Furthermore, the invention relates to a method for normalizing object situations for supporting the control method defined above, a system defined above and/or using a method for normalizing object kinds, in particular collecting and/or using declarative object knowledge, further comprising the following steps:
Initiate (D01) a spatial view,
Establish (D02) a purpose of the spatial consideration in the form of at least one indication of purpose of the spatial consideration,
Detecting (D03) at least one actual object in a space section,
Assigning (D04) the actual object to an object kind to which the actual object belongs, in particular assigning by reading out the object kind from a database,
Detecting (D05) a first information about a position, in particular relative position, of the at least one actual object in space, and
Determine (D06) a normalized object situation for the space section using the object kinds and the first information.

The task is also specifically solved by the method for learnable control of a process or a control system, also referred to herein as a control method. Accordingly, a method for teachable control of a process, a system or a control system, in particular for driving an actuator for converting the actuator from a start-object situation to a target-object situation by means of a controller, preferably an adaptive control or for automatically finding the solution to a problem or a task, in particular by collecting and/or using procedural event knowledge, is provided, comprising:
Define (S01) a task that consists of converting a specific start-object situation into a specific requested target-object situation by means of an event sequence (since the start-object situation is given, this corresponds to the definition of the desired target-object situation),
Reading (S02) a database, possibly on a server (of the company and/or of a service provider), for the purpose of searching for a suitable solution in the form of an event sequence which is suitable for solving the task, the database being suitable for associating at least the following variables with one another:
   an identifier of a possible start-object situation,
   Identifier of the object kinds involved,
   Identifier of a possible target-object situation,
   Identifier of the object kinds involved,
   an information about an event sequence, the event sequence being suitable for transferring the possible start-object situation to the possible target-object situation,
Selecting (S03a) an event sequence as a solution matching the task in the database when a solution matching the task has been read (S02), or
Building (S03b) a new event sequence, when a solution matching the task has not been read, as an n-concatenation from the existing event sequences, comprising the following steps:
   reading (S03b-01) the database to search at least a first and an n-th event sequence, in particular searching event sequences from a first to an n-th event sequence, where n denotes a natural number, and
      the first event sequence is suitable for transforming the possible start-object situation into a first intermediate object situation, and
      for all natural numbers for which 1<k<n holds, the k-th event sequence is suitable to transform a (k−1)-th intermediate object situation into a k-th intermediate object situation, and
      the nth event sequence is suitable to transform an (n−1)th intermediate object situation into the possible target-object situation,
   If necessary, storing a newly created event sequence as n-concatenation in the database, whereby the new concatenated event sequence is suitable for transferring the possible start-object situation to the possible target-object situation,
whereby the event sequences between two object situations can be initially collected and stored in any programming or description language, in particular in any programming or description language which is always uniform.

The advantages of the solution according to the invention result from the above explanations. In particular, a method is provided which can provide complex procedures for solving highly complex problems from simple building blocks in a dynamic manner. Through the use and maintenance of the database according to the invention, possibly in the cloud, the procedural event knowledge thereby becomes increasingly extensive. The control learns and becomes more and more efficient with increasing complexity.

Due to the abstraction provided, the invention can be used in all industrial fields of application, for example in industrial robots, autonomous or semi-autonomous control of vehicles or robot-controlled process automation. However, common to all fields of application of the method according to the invention is that at least one means is comprised which can be brought to implement at least one event from a chain of events.

A high abstraction is also provided on the part of the event sequences. These can be available in any programming or description language. Hereby the provided compatibility and the integration of the invention into already existing systems are again increased and supported. Partial sequences can be available, for example, in completely different descriptions, including any programming and description languages, but must always be uniform for the respective purpose in a technical equipment.

It is understood that a start-object situation herein describes the state (e.g. position) of an object or subject at a start time point in a space or space segment. For example, the gripper arm of a robot may have a certain position at the start time point. In contrast, the target-object situation describes a state of an object or subject at an end time point. For example, a gripper arm of a robot executes a movement starting from the start-object situation until the target-object situation is reached.

The skilled person understands by a sensor a technical component which can qualitatively or quantitatively measure certain physical or chemical properties (physically e.g. amount of heat, temperature, humidity, pressure, sound field parameters, brightness, acceleration or chemically e.g. pH value, ionic strength, electrochemical potential) and/or the material composition of its environment as a measurand. These variables are recorded by means of physical, chemical or biological effects and converted into a processable electrical signal (data).

An iteration (lat. repetition) is generally understood as the multiple execution of one or more instructions. The iteration is realized by loops. The loop is terminated by a termination condition. In the mathematical sense an iteration describes a procedure for the stepwise approximation to the solution of an equation under application of a repeating calculation process. An iterative search works like the depth-first search, but avoids its disadvantages regarding completeness by limiting the search depth. In an iterative search, a constrained depth search is performed iteratively, increasing the level to which the constrained depth search explores the graph by one at each iteration.

An input means is a means for transmitting data, which data may come directly from a sensor, a data transfer interface, a computer, or from a memory. An input means may include a current carrying element (e.g. an electrical line), a radio link establishing wireless interface (e.g. LTE, WLAN, Bluetooth, LoRaWAN), an optoelectronic transmission (e.g. laser), or any other means suitable to transmit and/or receive data.

A calculation means according to the invention preferably comprises an electronic calculation device (e.g. a computer), which is set up to perform a calculation on the basis of an command sequence. According to the invention, a computing means serves in particular to either determine an event sequence or to generate a (partial) event sequence as well as concatenations from (partial) event sequences.

In this context, cloud or cloud computing is understood to mean the Internet-based provision of storage space, computing power or application software as a service. These infrastructures are primarily used via programs (computer program products) on the accessing devices (clients) and via the web browser.

A server includes a program that waits for a client to contact it in order to perform a specific information technology service (service) for the client. The server's service is specific to the server, so that a separate server exists for each service. The data exchange between client and server is defined by a service-specific protocol.

The task is further solved by the method, in particular control method, for selecting and chaining procedures for forming a more complex procedure (event sequence). Accordingly, a method, in particular a control method, for selecting and chaining procedures or (partial) event sequences for forming a more complex procedure is provided, comprising at least the following steps:
Defining (B01) a task that consists of transforming a specific start-object situation into a specific target-object situation,
Iterating (B02a) over possible intermediate object situations as well as chainings of intermediate object situations, especially recursive iteration, as well as reading (B02b) a database for the purpose of finding suitable event procedures,
where a number n for each possible chaining of the intermediate object situations denotes the length of the respective chaining of the procedures and is given by a natural number greater than or equal to 2, and
   the first event sequence is suitable for converting the possible start-object situation into a first intermediate object situation, and
   for all natural numbers for which 1<k<n holds, the k-th event sequence is suitable to transform a (k−1)-th intermediate object situation into a k-th intermediate object situation, and
   the nth event sequence is suitable to transform an (n−1)th intermediate object situation into the possible target-object situation,
where any event procedure is suitable for either
   converting the possible start-object situation into the first intermediary object situation, or
   for a k with 1<k<n, convert the (k−1)th intermediate object situation to the kth intermediate object situation, or
   convert the (n−1)th intermediary object situation into the possible target-object situation and
wherein the chaining of the event procedures in the result is suitable to solve the task,
wherein the database is suitable to assign at least the following variables to each other:
   a first identifier of a possible first object situation,
   a second identifier of a possible second object situation
   information about an event sequence, the event sequence being particularly suitable for converting the possible first object situation into the possible second object situation,
Computing (B03) at least one quantitative suitability criterion of the chaining of procedures for each chaining caused by the iteration,
Selecting (B04) one or more concatenations based on at least one quantitative suitability criterion.

The advantages of the solution according to the invention result from the above explanations. In particular, a method is provided which can dynamically provide complex procedures for solving complex problems, if necessary in the cloud for several participants, from simpler modules. By using, updating and maintaining the database according to the invention, the procedural event knowledge thereby becomes more and more extensive. The control learns and becomes increasingly efficient.

The abstraction of procedural event knowledge provided allows the invention to be used in all industrial application areas, such as industrial robots, autonomous or semi-autonomous control of vehicles, or robot-controlled process automation.

A high abstraction is also provided on the part of the event sequences. These can be available in any programming or description language. Hereby the provided compatibility and the possible integration of the invention into already existing systems are again increased and supported. Partial sequences can be e.g. in completely different descriptions, among other things also completely different programming languages, must be however uniform.

The task is further solved by the industrial robot system. Accordingly, an industrial robot system is intended which is set up to execute the method according to the invention, in particular the control method and/or the method for selecting and chaining procedures for building a more complex procedure, wherein the industrial robot system further comprises:
at least one industrial robot, in particular an industrial robot suitable for online programming, in particular an industrial robot suitable for teach-in and/or master-slave and/or play-back,
a robot control for controlling the industrial robot, in particular adaptive control for controlling the industrial robot,
a memory and a CPU, which are arranged to provide the method according to the invention, in particular the control method and/or the method for selecting and chaining procedures for building a more complex procedure for the industrial robot, wherein the memory can in particular also be provided in a cloud and comprises a database arranged for said methods,
wherein, in particular after a run-in period, the database comprises event sequences of such high complexity that only less than two complex event sequences per tenth of a second are required for full load operation of the industrial robot, further in particular less than the decision for one event sequence per tenth of a second, further in particular less than three event sequences per second. The cloud could thus collect information from multiple facilities. The skilled person knows that the event sequences per time unit depends on the application and is variable.

This greatly reduces the load on the adaptive control, which saves time and energy. The entire system becomes more efficient, as increasingly complex event sequences are used as procedures for all participants. Part of the solution is also to generate and store all previously possible concatenations of procedural event sequences in the idle or sleep state of the device. This constantly adds to the list of complex procedural event sequences in a meaningful way.

The task is further solved by the system for a vehicle. Accordingly, a system for a vehicle, in particular motor vehicle, in particular driver assistance system or system for semi-automated or autonomous driving, is provided, which is set up to execute the method according to the invention, in particular the control method and/or the method for selecting and chaining procedures for forming a more complex procedure and/or to benefit from such execution, for example in a cloud, wherein the system further comprises:
a classical control of the vehicle, in particular a manual and/or adaptive control of the vehicle or a combination of such, a memory and a CPU, which are set up to provide the method according to the invention, in particular the control method and/or the method for selecting and chaining procedures for building a more complex procedure for the motor vehicle, wherein the memory can in particular also be provided in a cloud and comprises a database set up for said procedures, wherein the motor vehicle can communicate with the cloud via a data interface, in particular wireless data interface, in particular by means of a cellular connection, in particular 5G or further new standards,
wherein, in particular after an initial run-in time, the database comprises event sequences of such high complexity that only less than two event sequences per tenth of a second are required for the traffic operation of the motor vehicle, further in particular less than one event sequence per tenth of a second, further in particular less than ten event sequences per second.

This reduces the load on the vehicle's control system, which saves energy and time. The overall system thus becomes more efficient, as increasingly complex event sequences are used as procedures. Outsourcing to the cloud (“connected cars”) provides fast communication and high computing power or distributed computing. In addition, indications of hazards in traffic can be taken into account and coordination between vehicles is possible.

The task is further solved by the traffic control system. Accordingly, a traffic control system is provided comprising
a variety of motor vehicles, as well as per motor vehicle:
   a first communication interface, in particular a wireless interface, which is set up to communicate with other motor vehicles in a first immediate environment of the motor vehicle,
   a second communication interface, in particular a wireless interface, in particular by means of a cellular connection, in particular 5G, for communication with a cloud
wherein the traffic control system is arranged to provide the method according to the invention, in particular the control method and/or the method for selecting and chaining procedures for building a more complex procedure for at least one of the motor vehicles, in particular for two or more motor vehicles in a coordinated manner between the motor vehicles involved.

This reduces the load on the vehicle control system, which saves time and energy. The overall system becomes more efficient, as increasingly complex event sequences are used as procedures. Outsourcing to the cloud (“connected cars”) will provide fast communication and high computing power or distributed computing. In addition, indications of hazards in traffic can be taken into account and coordination between vehicles can be performed. Direct, even faster coordination can take place between vehicles directly, again promoting and ensuring smooth and safe overall dynamics of traffic control and flow.

The task is further solved by the device for robot-controlled process optimization. Accordingly, a device for robot-controlled process optimization comprising
a human-machine interface, in particular a desktop environment, in particular a desktop environment of a workstation PC comprising mouse and/or keyboard,
a sensor system which is set up to record an object situation of the man-machine interface,
a comparison unit which is set up to compare at least two object situations,
a memory and a CPU, which are set up to execute the method according to the invention, in particular the control method and/or the method for selecting and chaining procedures for forming a more complex procedure, wherein the memory can in particular also be provided in a cloud and comprises a database set up for said methods, wherein the motor vehicle can communicate with the cloud via a data interface, in particular a wireless data interface, in particular by means of a cellular connection, in particular 5G

This makes RPA even more automated and efficient. The increasingly complex procedures save energy and time and further increase efficiency and reliability.

In particular, ITSF can run on a commercially available PC or processor solution.

In another example, customer service requests are answered automatically. This becomes even faster, more precise and more accurate with ITSF. Due to the increasingly higher complexity, the “virtual customer service representative” continuously improves in his “lifetime” in a structured way.

The task is further solved by the method for robot-controlled process optimization. Accordingly, a method for robot-controlled process optimization comprising a method according to the invention, in particular a control method according to the invention and/or the method according to for selecting and chaining procedures for building a more complex procedure, wherein in particular the start- and target-object situations can designate virtual situations, wherein a system is provided, at least comprising
a human-machine interface, in particular a desktop environment, in particular a desktop environment of a workstation PC comprising mouse and/or keyboard,
a sensor system which is set up to record an object situation from the man-machine interface,
a memory and a CPU for processing, and

the method further comprises at least one step of a comparison, in which the existing actual object situation and the necessary target-object situation are compared with each other.

This makes RPA even more automated and efficient. The increasingly complex procedures save time and energy and further increase efficiency and reliability.

The task is further solved by the method for normalizing object kinds. Accordingly, a method for normalizing object kinds for supporting an adaptive control of a process, a system or a control system (each as defined herein), in particular by collecting and/or using declarative object knowledge, is provided, further comprising the following steps:
Initiating (C01) a spatial view,
Establishing (C02) a purpose of the spatial view in the form of at least one indication of purpose of the spatial view,
Detecting (C03) at least one specific object in a space section,
Assigning (C04) a specific object to an object kind, in particular a more general object kind, depending on at least one indication of purpose of the spatial observation,
Saving (C05) the assignment of the specific object and the object kind using a database.

Through the normalization of the object kinds, additional procedural event knowledge is made available for a specific problem solution. Through this, especially through the additional abstraction gained through normalization, a problem solution can be created for otherwise unsolvable problems or problems that can only be solved inefficiently and cumbersomely.

The task is further solved by the method for normalizing object situations. Accordingly, a method for normalizing object situations for supporting an adaptive control of a process, a system or a control system (each as defined herein) and/or using a method for normalizing object kinds as defined herein, in particular collecting and/or using declarative object knowledge, is provided, further comprising the following steps:
Initiating (D01) a spatial view,
Establishing (D02) a purpose of the spatial view in the form of at least one indication of purpose of the spatial view,
Detecting (D03) at least one specific object in a space section,
Assigning (D04) the specific object to an object kind to which the specific object belongs, in particular assigning by reading out the object kind from a database,
Detecting (D05) a first information about a location/position, in particular relative location/position, of the at least one specific object in space,
Determining (D06) a normalized object situation for the space segment using the object kinds and the first information.

Through the normalization of the object situations, additional procedural event knowledge is made available for a specific problem solution, related to more complex situations, usually comprising several objects and/or object kinds. Through this, in particular through the additional abstraction gained through normalization, a problem solution can be created for otherwise unsolvable problems or problems that can only be solved inefficiently and cumbersomely.

According to a further embodiment, the method according to the invention, in particular the control method further comprises a step of performing a complete or partial handover (S03c-1) of control over the process and/or the system to a control system, in particular conventional adaptive control system, if a suitable new event sequence could not be formed (S03b).

Thus, ITSF merely complements adaptive control, and there is no unnecessary hesitation in cases where classical/adaptive control is capable of solving the problem, but ITSF unfortunately is not (yet).

According to a further embodiment, the method according to the invention, in particular the control method, further comprises a step of supplementing (S03c-2) the database by one or more entries which are suitable for associating at least the following variables with each other:
an identifier of the possible start-object situation,
Identifier of the object kinds involved,
an identifier of the possible target-object situation,
Identifier of the object kinds involved,
an information about an event sequence, said event sequence being particularly suitable to transform the possible start-object situation into the possible target-object situation, and said information comprising an identifier allowing to identify said event sequence and/or one or more information based on an observation of the events of a control by said control system, in particular said conventional adaptive control system.

This is how ITSF learns. Thus, ITSF not only learns through new, more complex event sequences that it has formed itself, but also learns directly from adaptive and/or classical control. The procedures learned in this way are stored in the database, and ITSF can later form more complex event sequences on its own by considering and using the newly recorded sequence as a building block for this purpose.

Thus, ITSF allows to obtain new basic building blocks of event sequences in parallel as well as to further complexify them by continuous concatenation.

According to a preferred embodiment, the selection of an event sequence from an amount of suitable event sequences in step S03b1 is performed on the basis of at least one quantitative characteristic or suitability criterion, in particular as a dynamically calculated suitability criterion and/or a suitability criterion stored in the database. Examples of such quantitative features are, as set forth hereinafter, a success indicator, a time duration indicator, an effort indicator and/or a cost indicator, a time indicator and/or a timestamp (also referred to herein as timestamp).

According to a further embodiment, the database is therefore further suitable for also comprising and/or assigning the following variables in the database, in particular to the other variables:
a success indicator (also referred to herein as a success rating) that quantifies a degree of successful execution of an event sequence, in particular a degree of success, in the previous attempted and/or already executed execution of the event sequence.

Success is an essential decision factor for or against an event sequence. In particular, this is the case when there are several possible ways to solve a problem. Thus, the probability of success and, as a result, efficiency can be maximized with ITSF.

According to a further embodiment, the database is further suitable to also comprise and/or assign the following variables in the database, in particular to the other variables:
a time duration indicator (herein also referred to as duration), which quantifies a time duration, and/or a variable corresponding to a time duration, of an execution of an event sequence, in particular a successful execution of an event sequence, in particular a degree of success in the previous attempted and/or executed execution of the event sequence. An example of a time indicator is the classification according to the shortest distance and least number of partial event sequences (process steps).

The time duration/execution speed is another essential decision factor for or against an event sequence. In particular, this is the case when there are several possible ways to solve a problem. Thus, the total time duration and, as a result, the efficiency can be maximized with ITSF.

According to a further embodiment, the database is further suitable to also comprise and/or assign the following quantities in the database, in particular to the other quantities:
an effort indicator and/or cost indicator, which quantifies an effort, in particular energy effort or total effort of an execution, an execution of an event sequence, in particular a successful execution, in particular a calculated variable from one or more of energy effort, computing effort, organizational effort, time effort, costs, coordination effort, risk costs.

A specified effort, especially but not necessarily an energy or cost effort, is another major decision factor for or against an event sequence. In particular, this is the case when there are several possible ways to solve a problem. For example, the total cost or total energy required can be minimized and, as a result, efficiency can be maximized by ITSF. Therefore, an effort and/or cost indicator is preferably used as a quantitative attribute.

According to a further embodiment, the database is further suitable to also comprise and/or assign the following variables in the database, in particular to the other variables:
a time indicator and a time stamp/timestamp indexing a time of a recording of a sequence, in particular a time of a first recording of a sequence, and/or a time of a first successful execution/reproduction of the event sequence.

In particular, this makes it possible to assess how solid and/or established a procedure already is in the long term. The reference to the first successful execution/reproduction also ensures that unsuccessful attempts do not falsify the result.

According to a further embodiment, the database is further adapted to also utilize energy consumption (also referred to herein as effort) as a quantitative attribute.

According to a further development, the database is further suitable for also comprising and/or assigning the following variables in the database, in particular to the other variables:
A correlator of at least two, but especially three or more, event sequences, in particular a correlator, which quantifies a correlation for one or more of: Probability of success and/or success indicator, time expenditure, energy consumption, in particular a success correlator and/or an energy consumption correlator.

According to a further embodiment, the method according to the invention, in particular the control method, particularly preferably within step (c) of the control method, comprises the matching of the determined event sequences with and/or the database further comprises a success correlation table and/or event sequences/subprocedures synergy table, which is suitable for the inclusion and/or management of correlators, in particular of those which quantify a correlation for one or more of: Probability of success and/or success indicator, time expenditure, energy consumption, in particular success correlators and/or an energy consumption correlator of event sequences/subprocedures.

According to a further embodiment, the method further comprises a step of a premature termination (S03c) of a search (S03b-01) for suitable event sequences, which is executed if at least a predetermined safety period has elapsed since the start of the search (S03b-01) and no suitable result has been found so far, in particular no result which also satisfies a predetermined suitability criterion, has been found, wherein in particular the predetermined safety period depends on the purpose of the application and/or the type of system to be controlled and/or the adaptive control, wherein the safety period is in particular further suitable for quantifying a period of time until which an action is required for a smooth running of a process and/or the event sequence.

This avoids hesitation that can be damaging in dynamic systems (for example in an automotive traffic control system). The desired selection as an application-specific safety time period allows the special requirements of the respective application to be specifically addressed (see also in particular the respective specific applications).

According to a further embodiment, the method according to the invention, in particular the control method, particularly preferably within step (c) of the control method further comprises a step of comparing an effort indicator and/or cost indicator, in particular an energy consumption, of the event sequence with an energy supply of a technical device, in particular with an energy supply allocated to the process, the system or the control system and/or present in the system or the control system.

According to a further embodiment, the method further comprises a step of performing a complete or partial handover (S03c-1) of control of the process and/or the system to a control system, in particular conventional adaptive control system, which is performed after performing the step of a premature abort.

This performs the problem solving and ensures that there is no harmful procrastination. In addition, ITSF is given a one-time demonstration of the problem solution, which allows ITSF to continue learning.

According to a further embodiment, the method further comprises the following steps:
a step of recording the operations (event sequences) of the conventional control system, in particular of the conventional adaptive control system, which transfer the system from a start-object situation to a target-object situation, and/or
a step of storing at least one new entry in the database for the recorded operations, specifying at least one indicator of the start-object situation and one indicator of the target-object situation.

In this way, ITSF saves the pre-executed problem solution and stores it in the database ready to be called. By storing it in the database, this sequence of events is available to ITSF in the future as a solution to the problem or as a solution to a subproblem. Thus, ITSF can take over the solution of the problem in the future, which will relieve the adaptive control in the future. In addition, ITSF can use the problem solution as a building block for solving even more complex problems.

Thus, filing a valuable single building block may open up large areas of new complex procedures from ITSF.

According to a further embodiment, the method further comprises a step of comparing an effort indicator and/or cost indicator, in particular energy consumption, of the event sequence with an energy supply of a technical device, in particular with an energy supply allocated to the process, the system or the control system and/or present in the system or the control system.

In this way, efficiency can be optimized. In particular, full consideration can be given to user wishes/available resources/external constraints and/or a combination thereof, especially a weighted combination of these factors. In this way, ITSF produces the result that is optimally tailored to the specific situation and circumstances.

According to a further embodiment, the memory of the industrial robot further comprises instructions for a loading, in particular initial loading, of the database by using the classical control, in particular an adaptive control, wherein, in particular after an initial loading, the industrial robot is set up so that only less than two event sequences per tenth of a second are required for full-load operation of the industrial robot, further in particular less than one event sequence per tenth of a second, further in particular less than three event sequences per second, and/or a relief of the classical control, in particular the adaptive control, takes place.

Initial loading already activates ITSF and puts the industrial robot in a state where it is already working highly efficiently with ITSF and can hand over much of the control to ITSF. This eliminates the need for initial training, for example at the customer's site, and ensures an immediately efficient and fully functional start.

### EXAMPLES OF THE INVENTION

The present invention is explained in more detail below with reference to the embodiments indicated in the schematic figures of the drawings. They show as follows:

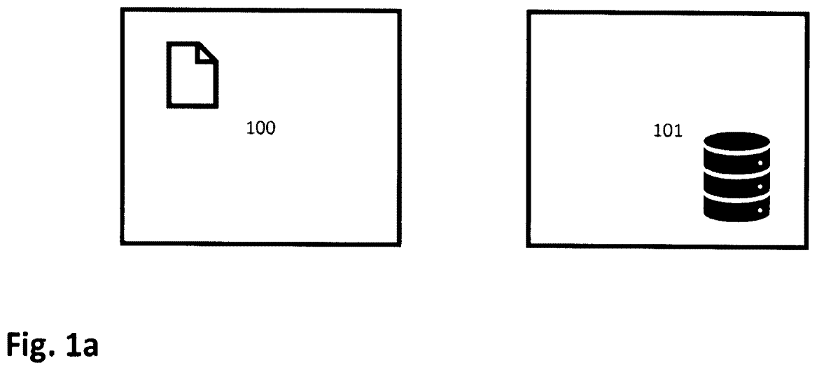

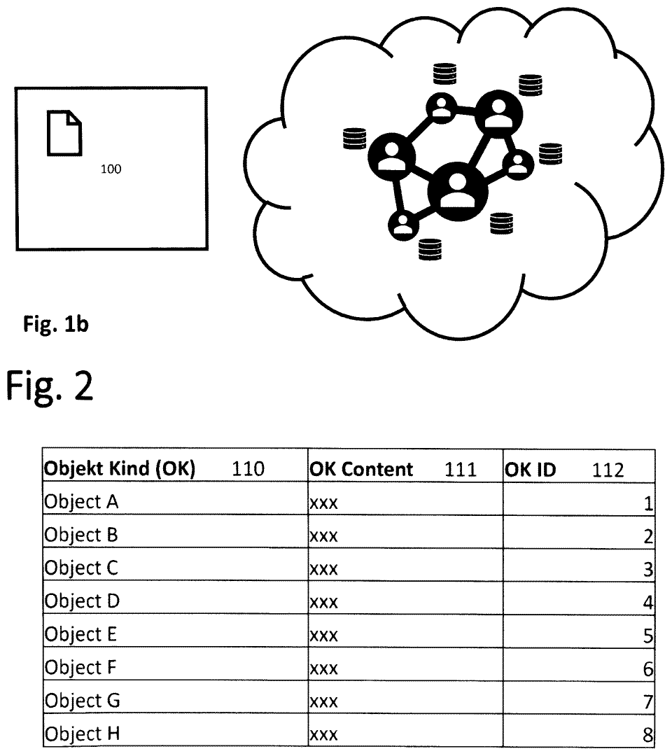

FIG. 1a is a schematic diagram for the purpose of illustrating the present invention, showing schematically a system suitable for use with the present invention,

FIG. 1b is a schematic diagram for the purpose of illustrating the present invention, showing schematically another system suitable for use with the present invention,

FIG. 2 is a schematic representation of a table (list of object kinds) for the purpose of illustrating the present invention in the context of an embodiment that employs an entity-relationship model,

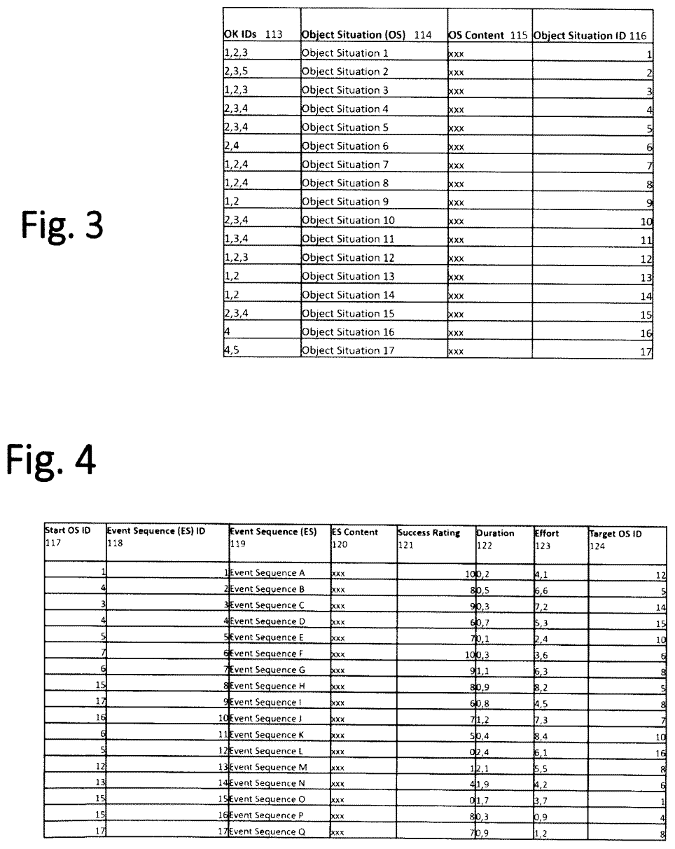

FIG. 3 is a schematic representation of a table (list of object situations) for the purpose of illustrating the present invention in the context of an embodiment that employs an entity-relationship model,

FIG. 4 is a schematic representation of a table (list of procedural event sequences) for the purpose of illustrating the present invention in the context of an embodiment that employs an entity-relationship model,

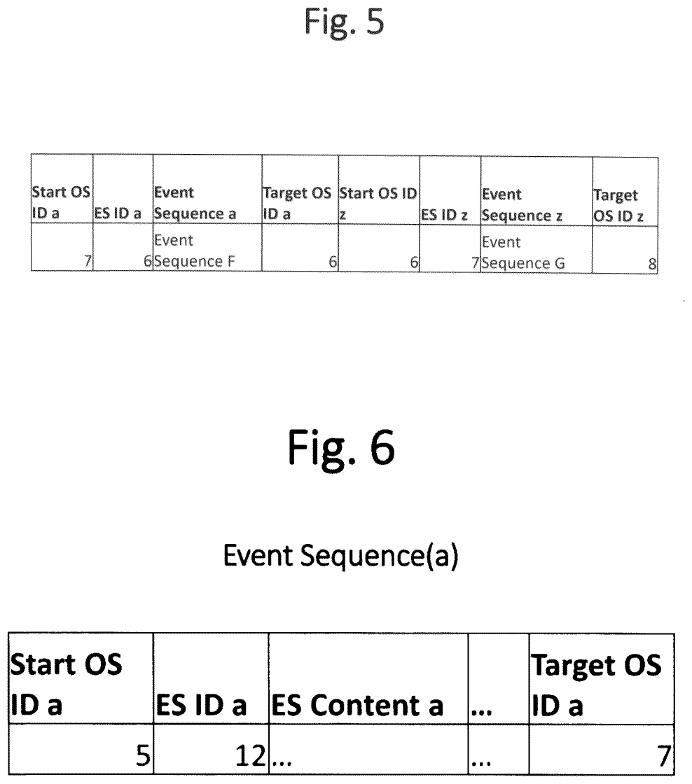

FIG. 5 is a schematic diagram of a database entry for the purpose of illustrating the present invention,

FIG. 6 is a schematic diagram of a database entry for the purpose of illustrating the present invention,

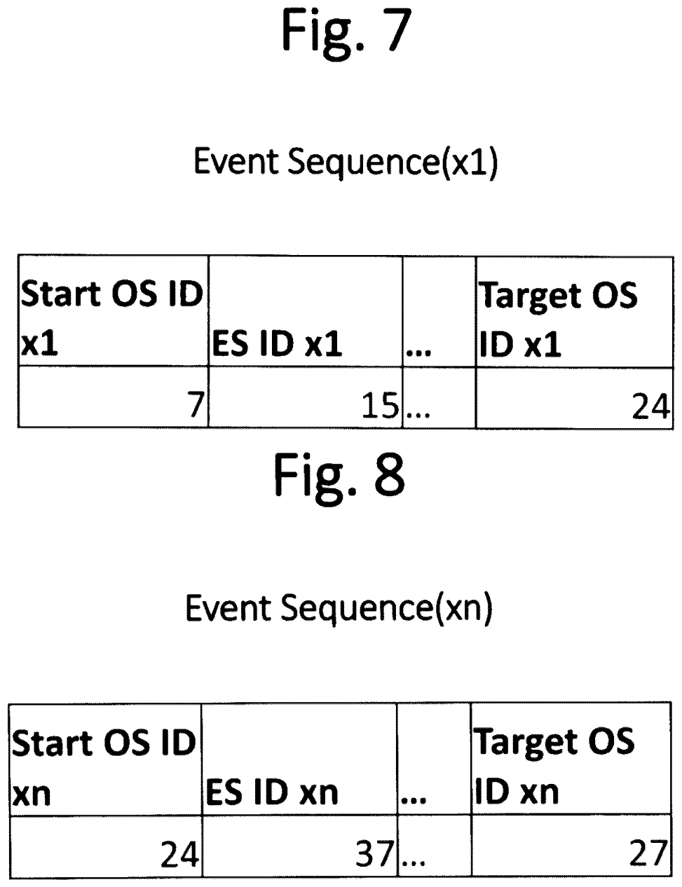

FIG. 7 is a schematic diagram of a database entry for the purpose of illustrating the present invention,

FIG. 8 is a schematic diagram of a database entry for the purpose of illustrating the present invention,

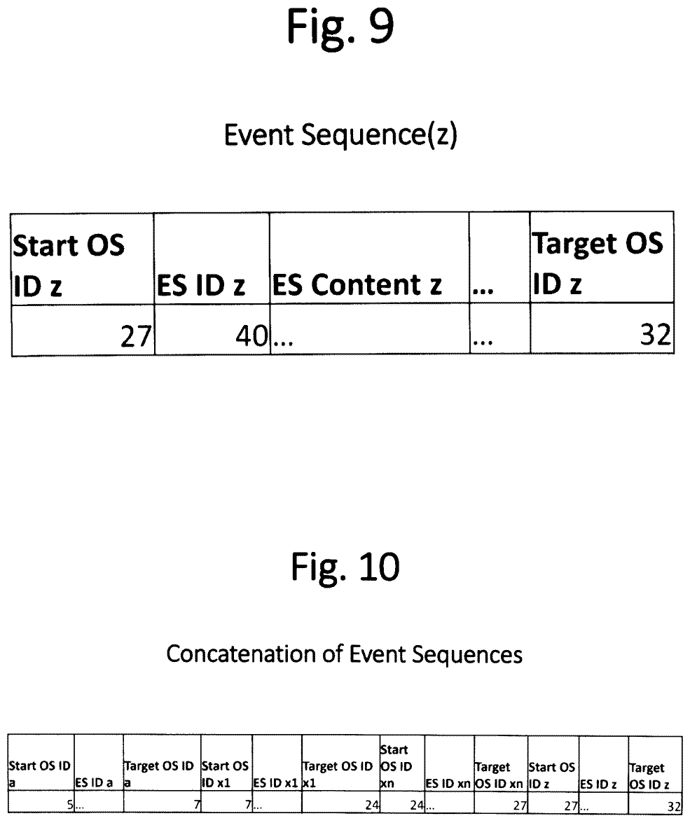

FIG. 9 is a schematic diagram of a database entry for the purpose of illustrating the present invention,

FIG. 10 is a schematic diagram of a database entry for the purpose of illustrating the present invention,

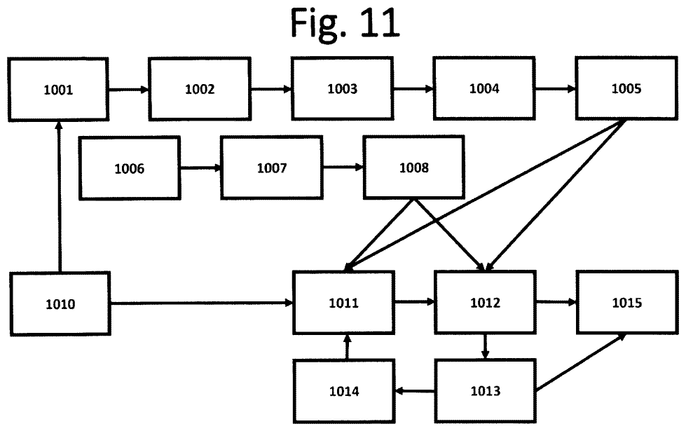

FIG. 11 is a schematic diagram of a knowledge process flow for the purpose of illustrating the present invention.

The figures merely illustrate examples of possible embodiments and aspects of the present invention.

FIG. 1a shows a schematic diagram for the purpose of illustrating the present invention, which schematically shows a system suitable for use with the present invention. A computer 100 having a memory 101 for a database is in principle suitable for use with the methods of the invention.

FIG. 1b shows another schematic diagram for the purpose of illustrating the present invention, which schematically shows another system suitable for use with the present invention. In this example, the database is in a cloud or distributed system, such as a distributed computer network. Calculation steps of the methods can also be performed in this distributed system.

It is also possible to transmit a computer program according to the invention, wire-bound or wireless, over such a computer network.

FIG. 2 shows a schematic representation of a table (list of object kinds) for the purpose of illustrating the present invention in the context of an embodiment that employs an entity-relationship model.

In one example, a list of object kinds, for example in the form of a database table, is used. For example, an object kind 110 is assigned to a content 111 of the object kind, and an identifier 112 is also assigned. In this example, the identifiers 112 are assigned consecutively numerically, but this does not have to be the case at all.

FIG. 3 shows a schematic representation of a table (list of object situations) for the purpose of illustrating the present invention in the context of an embodiment which employs an entity-relationship model.

In one example, a list of object situations, for example in the form of a database table, is used. Assigned to the object situations 114, for example, are the IDs 113 of the object kinds of the objects which are contained and/or recognized in the respective object situation 114. A content 115 of the object situation can also be assigned. In addition, identifiers 112 may be assigned. In this example, the identifiers 112 are assigned consecutively numerically, but this need by no means be so.

As will become clear in the following discussion, such a database table facilitates the handling and management of relevant procedural event knowledge. In addition, the object kinds create a further profitable level of abstraction compared to the specific objects. This further increases the reusability of procedural event knowledge. For example, an existing procedure can be applied to another concrete object, but of the same object kind.

This increases the efficiency of the overall system. A larger share of tasks can be taken over directly by ITSF and the learning curve, especially already the initial learning curve, is steeper.

FIG. 4 shows a schematic representation of a table (list of procedural event sequences) for the purpose of illustrating the present invention in the context of an embodiment that employs an entity-relationship model.

In one example, a list of procedural event sequences, for example in the form of a database table, is used. For example, an event sequence 119 is assigned an ID 118, information about a start-object situation, for example a corresponding ID 117, and information about a target-object situation, for example a corresponding ID 124, as well as a corresponding content 120.

In this context, the event sequence can transfer the start-object situation (ID 117) to the target-object situation (ID 124) by means of its content 120. For example, the content contains instructions in a programming and/or description language. In this or another example, the content contains further references and references to other content.

Further quantities and identifiers can be assigned. For example, a success indicator 121, a time duration indicator 122 and an effort indicator 123 are assigned in this way.

FIG. 5 shows a schematic diagram of a database entry for the purpose of illustrating the present invention. (Target OS ID a=Start OS ID z).

The concatenation of two event sequences shown here creates a new event sequence. Only one example is shown. The sequence F, which transfers the object situation “7” into the object situation “6”, is concatenated with the sequence G, which transfers the object situation “6” into the object situation “8”. This creates a new event sequence which is suitable for transferring the object situation “7” into the object situation “8”.

Such an event sequence can also be stored in the list (cf. FIG. 4).

FIG. 6 shows a schematic representation of a database entry for the purpose of illustrating the present invention. FIG. 7 shows a schematic representation of another database entry for the purpose of illustrating the present invention. FIG. 8 shows yet another schematic representation of a database entry for the purpose of illustrating the present invention. FIG. 9 shows yet another schematic representation of a database entry for the purpose of illustrating the present invention.

The sequences of FIGS. 6-9 can be concatenated according to the invention, since Target OS ID a=Start OS ID x1, Target OS ID x1=Start OS ID xn, Target OS ID xn=Start OS ID z.

FIG. 10 shows a schematic diagram of a database entry for the purpose of illustrating the present invention. (Target OS ID a=Start OS ID x1, Target OS ID x1=Start OS ID xn, Target OS ID xn=Start OS ID z)

The concatenation results in a new event sequence which is suitable for transferring the object situation “5” to the object situation “32”. For this purpose, the sequences of FIGS. 6-9 are concatenated according to the invention.

Such an event sequence can also be stored in the list (cf. FIG. 4).

FIG. 11 shows a schematic diagram of a knowledge process flow for the purpose of illustrating the present invention.

The upper five steps or units 1001-1005 refer to the start-object situation. The three steps or units 1006-1008 refer to the target-object situation. The steps or units 1010-1015 refer to the event sequences, i.e. the procedural event knowledge.

Here, new procedures are added as needed, as well as new concatenations are created and saved for further direct usability.

Particularly important is the writing back of the found concatenations of event sequences into the list of the ascertained event sequences (1014). About these develops thus fully automatically a higher and higher complexity in the list of event sequences.

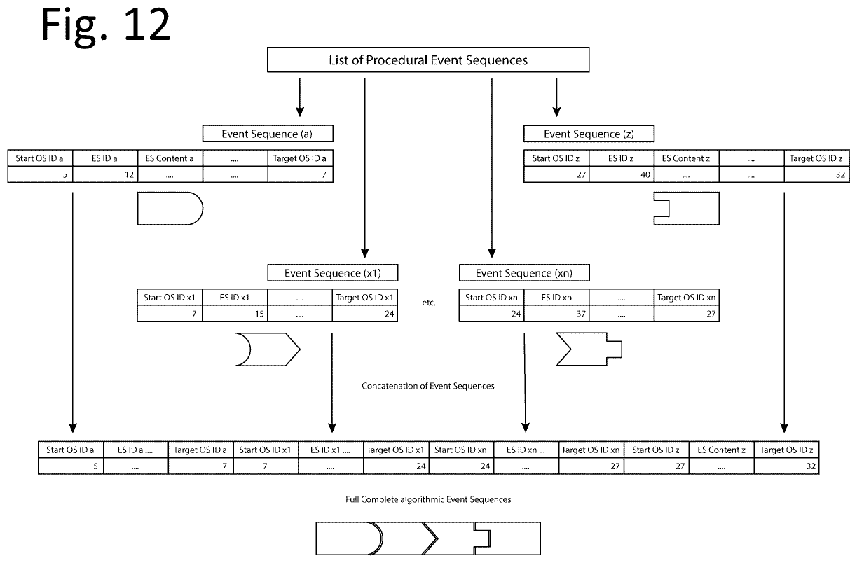

FIG. 12 shows an example of concatenation of event sequences. The sequences a, x1, xn and z are stored in a database. Each event sequence comprises an identifying feature (Start OS ID) of a start-object situation as well as an identifying feature of a target-object situation (Target OS ID). The sequences are each represented by a puzzle piece whose left and right sides represent different shapes, each representing a particular start- and target-object situation, respectively. For example, the event sequence x1 has a target-object situation with ID 24, while the event sequence has a start-object situation with ID of 24. Therefore, these two object situations may follow each other. Last, a concatenation of the event sequences is shown, forming an event sequence suitable to reach the target-object situation with ID 32 starting from the start-object situation of the event sequence a with ID 5. Below are shown the puzzle pieces of the event sequences whose start- and target-object situations match due to the same start- and object situations.

### Bezugszeichenliste

100 Computer system
101 Memory with database
110 Object Kind (OK)
111 Object Kind Content
112 Object Kind ID
113 Object Kind IDs
114 Object Situation (OS, object situation)
115 Object Situation Content
116 Object Situation ID
117 Start OS ID
118 Event Sequence ID
119 Event Sequence (ES, Event Sequence)
120 Event Sequence Content
121 Success Rating
122 Duration
123 Effort
124 Target OS ID
1001 Object Analysis and Identification
1002 Object Kind Identification for all Objects in Space Section
1003 Analyse Object Situation in Space Section
1004 Object Situation already in List or add a new Object Situation
1005 Defined Start-object Situation in Space Section, moment of now
1006 Defined Parameters for Target-Object Situation
1007 Calculated Target-Object Situation for the next moment
1008 Defined Target-Object Situation in space section, next moment
1010 Start Transcripting Procedural Event Sequences
1011 Storing new Procedural Event Sequence only for the first one time
1012 Calling stored Event Sequence by using Start- and Target-Object Situations
1013 Concatenation of more than one Procedural Event Sequences with Target−OSa=Start−OSz
1014 Storing a new Concatenation of more than one Procedural Event Sequences
1015 Well-defined Procedural Event Sequences from Start-OS to Target-OS

1. A control method for driving an actuator for converting a start-object situation into a target-object situation by means of a control, preferably an adaptive control, comprising:
a) Determining (S01) a start-object situation by means of a sensor,
b) Defining (S02) a target-object situation,
c) Determining (S03) an event sequence suitable for converting the start-object situation into the target-object situation from a set of known (partial) event sequences by
Iterative search (S03a) of known (partial) event sequences comprising the start- and/or target-object situation and/or object situations from partial event sequences of previous iteration steps,
Selecting (S03b1) at least one event sequence for converting the start-object situation into the target-object situation or building (S03b2) a new event sequence for converting the start-object situation into the target-object situation on the basis of the partial event sequences found in the substep of the iterative search and their concatenations,
d) Driving (S04) of the actuator based on the determined event sequence by the control.

2. The method of claim 1, wherein the step of selecting (S03b1) the event sequence from an amount of suitable event sequences is based on at least one quantitative suitability criterion.

3. The method of claim 1, wherein an effort and/or cost indicator is used as a quantitative suitability criterion.

4. The method of claim 2, wherein energy consumption is used as a quantitative suitability criterion.

5. The method of claim 2, wherein a success indicator is used as a quantitative suitability criterion.

6. The method of claim 1, wherein the sensor data determined in step (a) is normalized before being used to determine the start-object situation.

7. The method of claim 1, further comprising a step of storing (S05) the determined sequence of events.

8. The method of claim 1, further comprising a step of terminating step (c) of the method if no suitable event sequence for reaching the target can be determined and/or the control cannot perform the step of determining an event sequence for reaching the target-object situation.

9. The method of claim 8, wherein step (c) of the method is automatically terminated after the elapsing of a predefined period of time.

10. The method of claim 8, further comprising a step of adding a (partial) event sequence newly determined by the control to the amount of known (partial) event sequences.

11. The method of claim 1, further comprising a step of automatically supplementing the known event sequences with possible further event sequences while the method is not used to reach a target-object situation.

12. A system for driving an actuator for converting a start-object situation into a target-object situation by means of a control, preferably an adaptive control, comprising:
a) Input means for receiving (S01) a start-object situation from a sensor,
b) Input means for receiving (S02) a target-object situation,
c) Computing means for determining (S03) an event sequence suitable for converting the start-object situation to the target-object situation from an amount of known (partial) event sequences by
Iterative search (S03a) of known (partial) event sequences comprising the start- and/or target-object situation and/or object situations from partial event sequences of previous iteration steps,
Selecting (S03b1) at least one event sequence for converting the start-object situation into the target-object situation or building (S03b2) an optimized event sequence for converting the start-object situation into the target-object situation on the basis of the (partial) event sequences found in the partial step of the iterative search and their concatenations,
d) Output means for outputting a control signal for driving (S04) the actuator based on the determined event sequence by the control.

13. The system of claim 12, further comprising means for detecting known sequences of events and/or known object situations and/or associations therebetween.

14. The system of claim 12, further comprising means for storing at least one of a success indicator and/or at least one of a time duration indicator and/or an effort indicator and/or at least one of a cost indicator and/or at least one of a relevant time point for event sequences.

15. A computer program product comprising instructions which, when the program is executed by a computer, cause the computer to implement step (c) of the method of claim 1.

16. A computer-readable medium on which is stored the computer program product of claim 15.

17. A computer comprising at least one computer readable medium of claim 16.

18. A control, preferably an adaptive control, comprising a computer of claim 17.

19. A computer program product comprising instructions which, when the program is executed by a computer, cause the computer to human-readably represent results of a computer program of claim 15, or to convert the results into another (data) format which can be human-readably represented by a further computer program product, and/or to cause the computer program product to implement the method.

20. An industrial robot system comprising at least one industrial robot, at least one control system of claim 12, a sensor for detecting a start-object situation, and an actuator for converting a start-object situation into a target-object situation.

21. A vehicle guidance system, preferably for a motor vehicle, in particular driver assistance system or system for semi-automated or autonomous driving, comprising a control system of claim 12, a sensor for determining a start-object situation, and an actuator for converting a start-object situation into a target-object situation.

22. A traffic control system suitable for implementing the method of claim 1, comprising:
a variety of motor vehicles, as well as per motor vehicle:
a first communication interface, in particular a wireless interface, which is set up to communicate with other motor vehicles in a first immediate environment of the motor vehicle,
a second communication interface, in particular wireless interface, in particular by means of a cellular connection, in particular 5G, for communication of all vehicles with a server.

23. A device for robot-controlled process optimization, comprising:
a human-machine interface, preferably a desktop environment, preferably a desktop environment of a workstation PC comprising mouse and/or keyboard,
a sensor which is set up to record an object situation of the man-machine interface,
a comparison unit which is set up to compare at least two object situations,
a memory and a CPU which are adapted to execute the control method of claim 1,
wherein the memory can in particular also be provided in a cloud and comprises a database set up for said methods,
wherein a robot can communicate with the cloud via a data interface, in particular a wireless data interface, in particular by means of a cellular connection, in particular 5G.

24. A method for robot-controlled process optimization, comprising a method of claim 1 and/or the system of claim 12, wherein in particular the start- and target-object situations may denote virtual situations, wherein a system is provided at least comprising
a human-machine interface, in particular a desktop environment, in particular a desktop environment of a workstation PC comprising mouse and/or keyboard,
a sensor system which is set up to record an object situation from the man-machine interface,
a memory and a CPU for processing, and
wherein the method further comprises at least one step of a comparing step, wherein two necessary object situations are compared with each other.

25. A method for normalizing object kinds to support the control method of claim 1, of the system of claim 12, in particular collecting and/or using declarative object knowledge, further comprising the following steps:
nitiating (C01) a spatial view,
Establishing (C02) a purpose of the spatial view in the form of at least one indication of purpose of the spatial view,
Detecting (C03) at least one specific object in a space section,
Assigning (C04) a specific object to an object kind, in particular a more general object kind, depending on at least one indication of purpose of the spatial observation, and
Saving (C05) the assignment of the specific object and the object kind using a database.

26. A method for normalizing object situations for supporting the control method of claim 1, of the system of claim 12 and/or using the method for normalizing object kinds of claim 25, in particular collecting and/or using declarative object knowledge, further comprising the following steps:
Initiating (D01) a spatial view,
Establishing (D02) a purpose of the spatial view in the form of at least one purpose statement of the spatial view,
Detecting (D03) at least one specific object in a space section,
Assigning (D04) the specific object to an object kind to which the specific object belongs, in particular assigning by reading out the object kind from a database,
Detecting (D05) a first information about a position, in particular relative position, of the at least one specific object in space, and
Determining (D06) a normalized object situation for the space segment using the object kinds and the first information.
